(19) United States
(12) Patent Application Publication
(10) Pub. No.: US 2016/0086511 A1
(43) Pub. Date: Mar. 24, 2016

(54) ELECTRONIC APPARATUS

(71) Applicant: Seiko Epson Corporation, Tokyo (JP)

(72) Inventor: Ryo NAKAGAWA, Chiba-shi (JP)

(21) Appl. No.: 14/958,896

(22) Filed: Dec. 3, 2015

Related U.S. Application Data
(63) Continuation of application No. PCT/JP2014/002771, filed on May 27, 2014.

(30) Foreign Application Priority Data
Jun. 7, 2013 (JP) 2013-120586

(51) Int. Cl. G09B 19/00; G09B 5/02; G06F 19/00

(52) U.S. Cl. CPC G09B 19/0092; G06F 19/3475; G09B 5/02

(57) ABSTRACT

To provide an electronic apparatus capable of performing determination processing for a calorie amount by a meal through easy input operation by performing discrimination processing for a mealtime based on time information received from a clocking unit.

The electronic apparatus includes an input-information acquiring unit 110 that performs acquisition processing for input information on the basis of an input from a user, a time-information acquiring unit 120 that acquires time information from a clocking unit 130, a discriminating unit 140 that performs discrimination processing for a mealtime on the basis of the time information, and a processing unit 150 that calculates meal amount information on the basis of the input information acquired by the input-information acquiring unit 110 and performs calculation processing for a calorie amount by a meal on the basis of the calculated meal amount information and a result of the discrimination processing in the discriminating unit 140.

### CROSS-REFERENCES TO RELATED APPLICATIONS

This application is a continuation of PCT Application No. PCT/JP2014/002771, filed May 27, 2014, and Japanese Patent Application No. 2013-120586, filed Jun. 7, 2013, all the entireties of which are hereby incorporated by reference.

### BACKGROUND

1. Technical Field

The present invention relates to an electronic apparatus and the like.

2. Background Art

In recent years, according to rising social health consciousness, services, electronic apparatuses, and the like for health maintenance and promotion have been widely used. In particular, for example, since a term “metabolic syndrome” has been publicly known concerning obesity, weight control has attracted more attention and electronic apparatuses and the like for performing the weight control have been used.

In the weight control, it is important to actually measure and record weight and fat mass. However, it is desirable to continuously acquire information concerning factors of weight fluctuation together with the measurement and recording of the weight and the fat mass. For example, it is known that a calorie balance of a subject has large influence on the weight fluctuation. Therefore, it is important to acquire information concerning exercise performed by the subject as information concerning calorie consumption and acquire information concerning meals taken by the subject as information concerning intake calorie.

For example, PTL 1 discloses a calorie balance tabulation device that integrates an intake calorie amount per predetermined period and integrates a calorie consumption amount per predetermined period to calculate a calorie balance of a target user.

### SUMMARY OF INVENTION

### Technical Problem

In the method of PTL 1, when estimating the intake calorie amount, processing for communicating with a data transmission terminal associated with a register in a restaurant or the like and acquiring eaten and drunk foods and an amount of the foods is performed. Therefore, restaurants and the like need to set terminals that transmit information concerning meals to an electronic apparatus. It is difficult to realize this from the viewpoint of costs and the like.

In methods of a modification and before the modification in PTL 1, a user manually inputs information concerning meals. However, in order to calculate a calorie amount from menus of meals, expertise such as nutrition science is necessary. Therefore, it is inappropriate to force a general user to input the information. Even if the electronic apparatus performs processing for calculating a calorie amount from menus, the user needs to input a menu taken in by the user in every meal. The input operation is extremely troublesome and is undesirable from the viewpoint of user friendliness.

On the other hand, there is known a method of calculating an intake calorie amount by a meal without inputting a detailed menu. For example, a standard value of an energy amount necessary in one day is described in “Meal Intake Standard of Japanese (2010)” and the like published by the Ministry of Health, Labor and Welfare. As explained in detail below, by using this data, it is possible to estimate an intake calorie amount by a meal on the basis of a mealtime and a meal amount. Consequently, the input by the user is facilitated compared with a method of directly inputting a calorie amount or inputting a detailed menu.

However, according to a result of data tabulation by the applicant, even if the input is limited to the mealtime and the meal amount, a ratio of users who do not input information concerning meals is extremely large. This is mainly because it is troublesome to input meal information in every meal. That is, further simplification of the input operation is necessary in order to ask users to appropriately input meal information, which is important information when health maintenance and promotion is taken into account.

According to some aspects of the invention, it is possible to provide an electronic apparatus capable of performing determination processing for a calorie amount by a meal through easy input operation by performing discrimination processing for a mealtime on the basis of time information received from a clocking unit.

### Solution to Problem

An aspect of the invention relates to an electronic apparatus including: an input-information acquiring unit configured to perform acquisition processing for input information on the basis of an input from a user; a time-information acquiring unit configured to acquire time information from a clocking unit; a discriminating unit configured to perform discrimination processing for a mealtime on the basis of the time information; and a processing unit configured to calculate meal amount information on the basis of the input information acquired by the input-information acquiring unit and perform determination processing for a calorie amount by a meal on the basis of the calculated meal amount information and a result of the discrimination processing in the discriminating unit.

In the aspect of the invention, the calorie amount by the meal is determined from the mealtime discriminated on the basis of the time information received from the clocking unit and the meal amount information calculated on the basis of the input information. Therefore, since it is possible to automatically discriminate the mealtime, it is possible to, for example, simplify a user input necessary for the determination processing for the calorie amount.

In the aspect of the invention, the input-information acquiring unit may perform the acquisition processing for the input information by tap operation by the user.

Consequently, it is possible to, for example, use the input information by the tap operation for processing.

In the aspect of the invention, when first to N-th (N is an integer equal to or larger than 2) meal amounts are set as a meal amount represented by the meal amount information, in a selected state of an i-th (i is an integer satisfying 1≦i≦N, i≠N) meal amount, when the input-information acquiring unit performs the acquisition processing for the input information by the tap operation, the processing unit may determine that an i+1-th meal amount is in a selected state and perform the determination processing for the calorie amount using the i+1-th meal amount as the meal amount information.

Consequently, it is possible to, for example, use the tap operation as operation for transitioning the meal amount in a selected state.

In the aspect of the invention, in a selected state of the N-th meal amount, when the input-information acquiring unit performs the acquisition processing for the input information by the tap operation, the processing unit may determine that the first meal amount is in a selected state and perform the determination processing for the calorie amount using the first meal amount as the meal amount information.

Consequently, when the last meal amount is in a selected state, it is possible to, for example, use the tap operation as operation for changing the first meal amount to a selected state.

In the aspect of the invention, the input-information acquiring unit may acquire personal data of the user as the input information, and the processing unit may perform, on the basis of the personal data, the meal amount information indicating a k-th (k is an integer satisfying 1≦k≦N) meal amount in a selected state, and the mealtime discriminated by the discrimination processing, the determination processing for a k-th calorie amount, which is the calorie amount corresponding to intake of a meal with the k-th meal amount at the mealtime by the user, and perform output processing for information for display control used for display of the k-th meal amount and the k-th calorie amount on the basis of the determination processing for the k-th calorie amount.

Consequently, it is possible to, for example, determine, on the basis of the personal data, the mealtime, and the meal amount information, a calorie amount of a meal corresponding thereto and perform control for displaying a meal amount in a selected state and a calorie amount corresponding to the meal amount.

In the aspect of the invention, the processing unit may perform mode switching processing for switching an operation mode of the electronic apparatus between an information display mode for performing display of information and a meal mode for performing processing concerning a meal, the time-information acquiring unit may acquire the time information at switching timing when the operation mode is switched from the information display mode to the meal mode by the processing unit, and the discriminating unit may perform the discrimination processing for the mealtime on the basis of the time information at the switching timing.

Consequently, it is possible to, for example, perform the discrimination processing for the mealtime on the basis of the time information at the timing of the mode switching processing to the meal mode.

In the aspect of the invention, the processing unit may perform mode switching processing for switching an operation mode of the electronic apparatus between an information display mode for performing display of information and a meal mode for performing processing concerning a meal, the input-information acquiring unit may perform the acquisition processing for the input information by tap operation by the user and the input information by an operation input of an operation unit, and, when the operation mode is the information display mode, when the input-information acquiring unit acquires the input information by the operation input of the operation unit, the processing unit may perform the mode switching processing for switching the operation mode to the meal mode.

Consequently, when receiving the tap operation and the operation by the operation unit, it is possible to, for example, use the operation by the operation unit as a trigger of the mode switching processing to the meal mode.

In the aspect of the invention, when a plurality of meal amounts are set as a meal amount represented by the meal amount information and when the operation mode is the meal mode, the processing unit may perform processing for changing, to a selected state, the meal amount different from the meal amount in the selected state before the tap operation among the plurality of meal amounts when the input-information acquiring unit performs the acquisition processing for the input information by the tap operation and may perform determination processing for the meal amount in the selected state and perform the mode switching processing for switching the operation mode to the information display mode when the input-information acquiring unit performs the acquisition processing for the input information by the operation input of the operation unit.

Consequently, when the tap operation and the operation by the operation unit are received in the meal mode, it is possible to, for example, use the tap operation as operation for changing the meal amount in the selected state and use the operation by the operation unit as operation for performing determination of the meal amount and the mode switching processing to the information display mode.

Another aspect of the invention relates to a control method for an electronic apparatus for causing the electronic apparatus to execute: processing for acquiring input information on the basis of an input from a user; processing for acquiring time information from a clocking unit; discrimination processing for discriminating a mealtime on the basis of the time information; processing for calculating meal amount information on the basis of the acquired input information; and processing for calculating a calorie amount by a meal on the basis of the calculated meal amount information and a result of the discrimination processing.

### BRIEF DESCRIPTION OF THE DRAWINGS

FIG. 1 is a system configuration example of an electronic apparatus according to this embodiment.

FIG. 2(A) is a setting example of base metabolism reference values and FIG. 2(B) is a setting example of physical activity levels.

FIG. 3 is a setting example of meal coefficients based on mealtimes and meal amount information.

FIG. 4 is a diagram for explaining an overall processing flow of the embodiment.

FIG. 5 is another example of a calorie-by-state table.

FIG. 6 is a diagram for explaining a processing flow in inputs of meals.

FIG. 7 is a flowchart for explaining discrimination processing in a discriminating unit.

FIG. 8 is an example of screen transition in the inputs of the meals.

FIG. 9 is a diagram for explaining a processing flow in inputs of meals in the conventional method.

FIG. 10 is a diagram for explaining a difference in the screen transition compared with the conventional method.

FIG. 11 is another diagram for explaining the processing flow in the inputs of the meals.

FIG. 12 is an explanatory diagram of tap operation.

FIG. 13 is a system configuration example of the electronic apparatus in which the tap operation is used.

FIG. 14 is a setting example of axes of an acceleration sensor.

FIG. 15(A) is a waveform example of an acceleration detection value and FIG. 15(B) is a waveform example indicating a detection result of the tap operation based on the acceleration detection value.

FIG. 16(A) and FIG. 16(B) are examples of operation in which a waveform of an acceleration detection value is similar to that in the tap operation.

FIG. 17(A) to FIG. 17(C) are waveform examples of acceleration detection values by the tap operation at different sampling frequencies.

FIG. 18(A) to FIG. 18(C) are waveform examples of acceleration detection values by a tuning action of a wrist at different sampling frequencies.

FIG. 19(A) to FIG. 19(C) are waveform examples of acceleration detection values by a swinging action of the wrist at different sampling frequencies.

FIG. 20(A) to FIG. 20(C) are waveform examples of acceleration detection values by the tap operation, the turning action of the wrist, and the swinging action of the wrist in a relatively short period.

FIG. 21 is a diagram for explaining a difference in an acceleration detection value due to sampling timing.

FIG. 22(A) and FIG. 22(B) are waveform examples at a low sampling frequency.

FIG. 23(A) and FIG. 23(B) are waveform examples at an intermediate sampling frequency.

FIG. 24(A) and FIG. 24(B) are waveform examples at a high sampling frequency.

### DESCRIPTION OF EMBODIMENTS

An embodiment is explained below. Note that the embodiment explained below does not unduly limit the content of the present invention described in the appended claims. Not all of components explained in this embodiment are essential constituent elements of the present invention.

1. Method in this Embodiment

First, a method in this embodiment is explained. As explained above, in a service for performing weight control or the like or an electronic apparatus used in the service, to input meal information as information concerning an intake calorie amount is required. This is based on the idea that a calorie balance is important in an increase and a decrease in weight and the influence by meals is large concerning an intake calorie amount in the calorie balance.

Various kinds of information are conceivable as information concerning meals. For example, it is also possible to cause the user himself or herself to estimate a calorie amount based on a meal and input a value of the calorie amount as in the conventional method. Alternatively, it is possible to cause the user to input a meal menu and perform, on an electronic apparatus side, processing for estimating an intake calorie amount from the meal menu. The meal menu is information indicating items included in a meal such as polished rice, miso soup, grilled fish, and pickles.

However, expertise such as nutrition science is necessary to estimate an intake calorie amount from a meal. Therefore, it is difficult to cause a general user to perform such estimation. Concerning the meal menu, in general, content and the number of items are different for each meal. Therefore, it is complicated to input all of the items. In particular, weight control or the like is performed for a long span of several months or more. Therefore, a burden on the user is large when the user inputs detailed meal menus for a long period.

On the other hand, as a method of automating an input of meal information, PTL 1 discloses a method of using a data transmission terminal associated with a register of a restaurant or the like. However, in PTL 1, it is necessary to provide apparatuses such as data transmission terminals in restaurants. Therefore, the method is unrealistic from the viewpoint of costs and the like.

There is also known a method of estimating an intake calorie amount by a meal with a simpler input using “Meal Intake Standard of Japanese (2010)” and the like published by the Ministry of Health, Labor and Welfare. As explained in detail below, the intake calorie amount is estimated on the basis of personal data such as age, sex, height, weight, and a physical activity level of the user, a mealtime, and meal amount information. The personal data only has to be input, for example, at the start of use of the electronic apparatus. Therefore, the intake calorie amount can be calculated if the mealtime and the meal amount information are input in every meal. The mealtime is information indicating whether a target meal is breakfast, lunch, or dinner.

However, when the applicant provided a service for requesting an input of the mealtime and the meal amount information and tabulated a large number of data, it has been found that a ratio of an appropriate input of information concerning meals is extremely low compared with a ratio of an appropriate input of data such as weight. When a hearing survey or the like for users was performed concerning the input of the information, a large number of opinions indicated that the input of the meal information was still complicated even if input content was limited to the mealtime and the meal amount information. As the meal information, information equivalent to the number of times of meals has to be continuously input in the span of several months or more as explained above. That is, in order to request the user to input sufficient meal information, further simplification of the input operation is necessary.

Therefore, the applicant proposes a method of automatically discriminating a mealtime on the basis of time information received from a clocking unit and calculating an intake calorie amount from a result of the discrimination and meal amount information input from the user. Consequently, it is possible to simplify or completely skip an input concerning the mealtime. Therefore, it is possible to, for example, facilitate input operation by the user concerning the meal information and urge a continuous input of meal information.

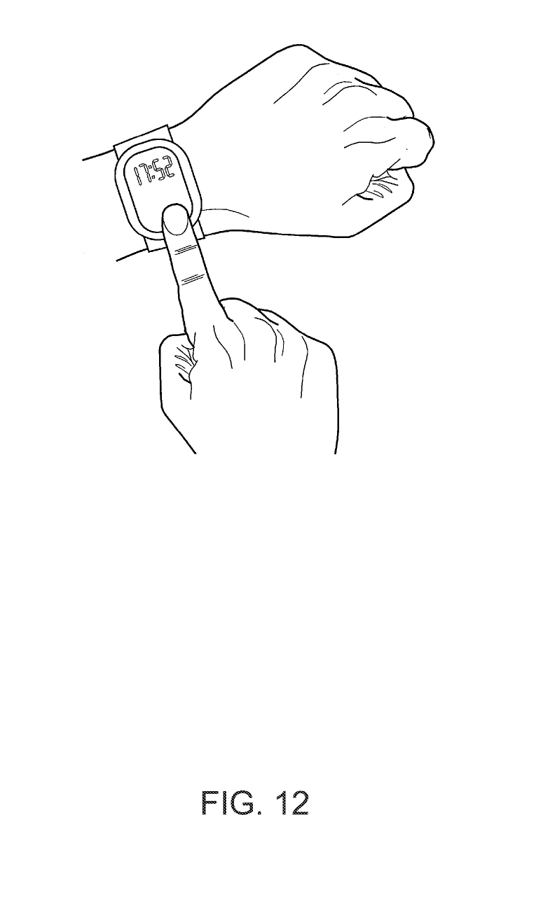

Note that, by using tap operation shown in FIG. 12 as an interface, it is possible to realize an easy interface compared with, for example, depression operation of a button or a key. Therefore, it is possible to more easily input meal information. Therefore, the input of the meal amount information may be performed by the tap operation as explained below.

In the following explanation, after a system configuration example of an electronic apparatus according to this embodiment is explained, the method of calculating an intake calorie amount on the basis of a mealtime and meal amount information is explained using “Meal Intake Standard of Japanese (2010)” and the like published by the Ministry of Health, Labor and Welfare. Thereafter, several specific processing flows are explained. A method of detecting tap operation using an acceleration sensor is explained taking into account that the tap operation is adopted as an interface. Finally, a specific example of this embodiment is explained.

2. System Configuration Example of the Electronic Apparatus According to this Embodiment

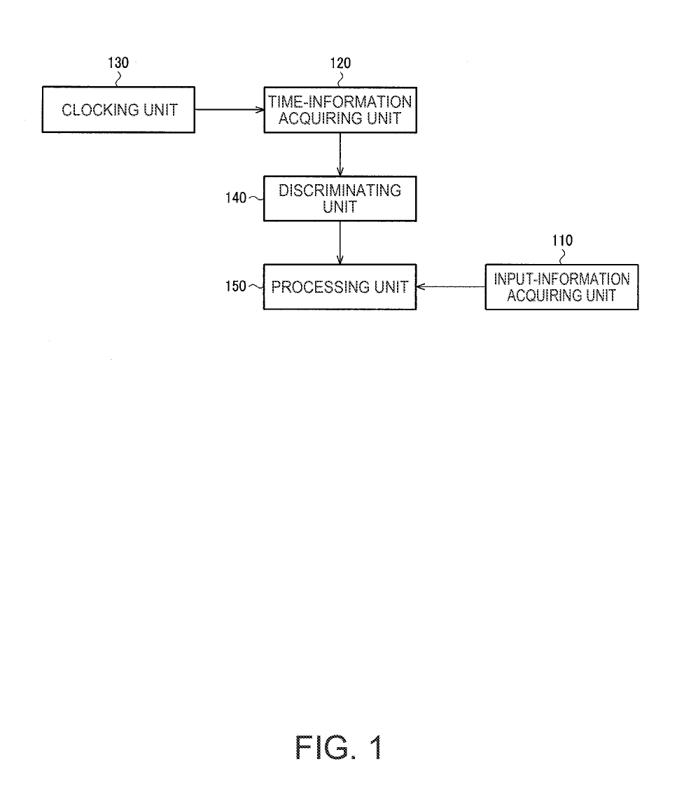

A system configuration example of the electronic apparatus according to this embodiment is shown in FIG. 1. As shown in FIG. 1, the electronic apparatus includes an input-information acquiring unit 110, a time-information acquiring unit 120, a clocking unit 130, a discriminating unit 140, and a processing unit 150. However, the electronic apparatus is not limited to the configuration shown in FIG. 1. As various modified implementations, for example, it is possible to omit a part of components of the electronic apparatus or add other components.

The input-information acquiring unit 110 performs acquisition processing for information input from the user. For example, when operation of an operation unit such as a button, a key, or a touch panel provided in the electronic apparatus is performed, the input-information acquiring unit 110 acquires operation information generated by the operation. The operation information may be a control signal for instructing the electronic apparatus to perform a specific operation. Alternatively, the operation information may be simple information indicating which key is operated. In that case, interpretation processing for the operation information may be performed by a processing section 150 or the like explained below and a specific operation of the electronic apparatus may be executed on the basis of a processing result.

The input information is not limited to the above. The input-information acquiring unit 110 may acquire personal data or the like representing, for example, age and sex of the user. Alternatively, as operation different from the operation of the operation unit such as the button, the key, or the touch panel, the tap operation shown in FIG. 12 may be received. Note that details of the tap operation are explained below.

The time-information acquiring unit 120 acquires time information from the clocking unit 130 and outputs the time information to the discriminating unit 140. The clocking unit 130 is realized by, for example, a clock or a counter and generates information such as time as time information. When the electronic apparatus in this embodiment is an arm-mounted electronic apparatus shown in FIG. 12, it is sufficiently conceivable that time is displayed on a display unit. The clocking unit 130 in that case corresponds to a clock used for time display.

The discriminating unit 140 discriminates a mealtime on the basis of the time information acquired by the time-information acquiring unit 120. The mealtime is information indicating timing when a meal is taken. Specifically, the mealtime may be information indicating whether a corresponding meal is breakfast, lunch, or dinner. Details of the discrimination processing are explained below.

The processing unit 150 performs, on the basis of the information acquired by the input-information acquiring unit 110 and a result of the discrimination processing in the discriminating unit 140, processing for calculating an intake calorie amount by a meal of the user. Specifically, the processing unit 150 calculates meal amount information on the basis of the information received from the input-information acquiring unit 110 and calculates a calorie amount on the basis of the calculated meal amount information and the mealtime, which is a result of the discrimination processing in the discriminating unit 140. Processing content based on the meal amount information and the mealtime is explained below. Note that the processing in the processing unit 150 is not limited to the above. The processing unit 150 may perform various kinds of processing in the electronic apparatus such as mode switching processing for an operation mode of the electronic apparatus.

### 3. Calorie Amount Determination Processing Based on a Mealtime and a Meal Amount

Details of calorie amount determination processing (in a narrow sense, calorie amount calculation processing) based on a mealtime and a meal amount are explained. This determination processing is based on “Meal Intake Standard of Japanese (2010)” published by the Ministry of Health, Labor and Welfare. In the reference explained above, an energy amount (a calories amount) necessary in one day is calculated by the following

Expression (1).

Weight×base metabolism reference value×physical activity level=energy amount necessary in one day (1)

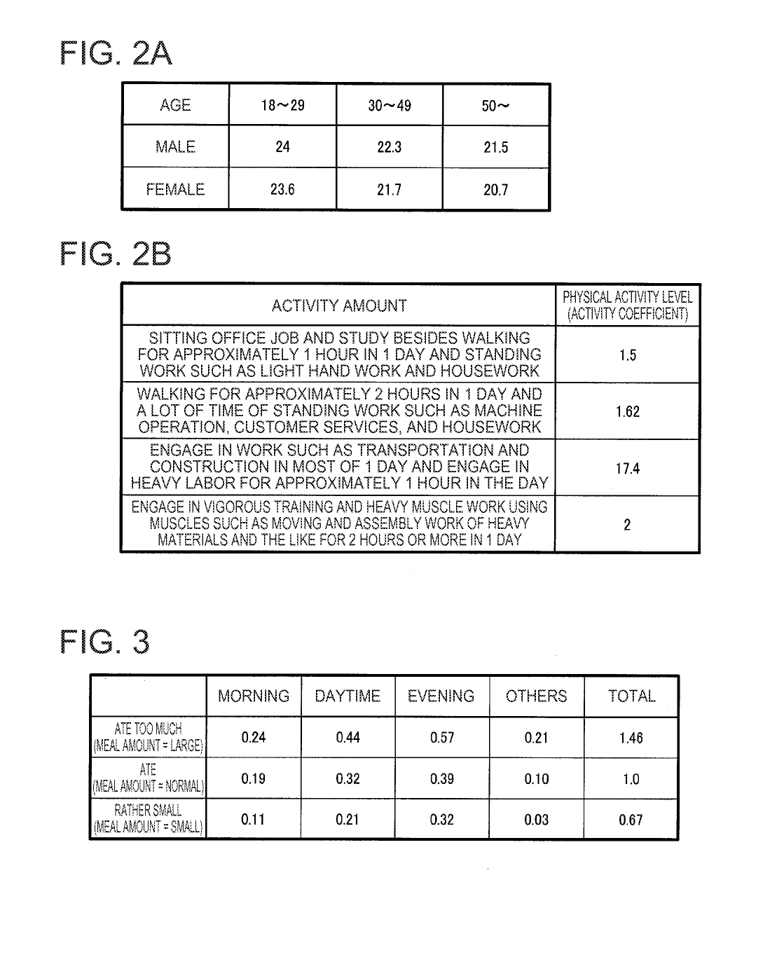

The base metabolism reference value is determined by sex and age. Values shown in FIG. 2(A) are used. The physical activity level is determined by a degree of exercise performed by the user in one day. Values shown in FIG. 2(B) are used. As it is seen from FIG. 2(B), the physical activity level is set larger for a user who performs more vigorous exercise.

The energy amount necessary in one day calculated by the above Expression (1) is multiplied by meal coefficients determined by mealtimes and meal amount information as indicated by the following Expression (2) to calculate intake calorie amounts in individual meals.

Energy amount necessary in one day×meal coefficients=calories of respective meals (2)

A specific example of the meal coefficients is shown in FIG. 3. As it is seen when viewing a row of ate (a meal amount=normal) in FIG. 3, when normal amounts of meals are taken concerning morning, daytime, night, and others indicating eating between meals, a sum of the meal coefficients is 1. That is, by taking the normal amounts of meals in one day, it is possible to take in the energy amount necessary in one day indicated by the above Expression (1).

As it is seen when numerical values are compared in the up-down direction concerning rows of morning, daytime, night, and others, in the case where ate too much (a meal amount=large), values of the meal coefficients are larger than values of the meal coefficients in the normal case. Therefore, a result is obtained in which the calorie amount calculated by the above Expression (2) is larger than the calorie amount in the normal case, that is, calorie is in an excessive intake state. Similarly, when a meal is rather small (a meal amount=small), the meal coefficients are small and the calculated calorie amount is smaller than the calorie amount in the normal case.

The lateral direction of the rows indicate in which degrees of ratios the calorie amount necessary in one day is taken in the respective meals. In general, it is easily understood that breakfast is a light meal with a small number of items or the like and meals with large calorie amounts including main dishes with a lot of meat and fish are taken in lunch and dinner. Differences in the meal coefficients in the lateral direction of the rows in FIG. 3 are based on such an idea. When breakfast of a given meal amount is eaten and when lunch of the same degree of the meal amount is eaten, the meal coefficient is larger in lunch (in the case of the meal amount=normal, 0.32>0.19) and the intake calorie amount is also larger. Similarly, the meal coefficients of dinner are slightly large compared with the meal coefficients of lunch with the same degree of the meal amount. Others are equivalent to eating between meals. Therefore, the meal coefficients are small and set to values smaller than the meal coefficients of breakfast of the same degree.

As indicated by the above Expression (1), the calorie amount necessary in one day is calculated from the base metabolism reference value and the physical activity level. The base metabolism reference value and the physical activity level are calculated from sex, age, and the like. If sex and age are input at the start of use of the electronic apparatus, information concerning the sex and the age can be continuously used. If physical activity level is set once, the physical activity level can be continuously used as long as an occupation, a lifestyle, or the like does not change.

That is, if individual data such as sex and age is acquired by the input-information acquiring unit 110 in advance, when meal information is input, it is possible to acquire a mealtime and meal amount information, set a meal coefficient, and calculate calorie in every meal from the above Expressions (1) and (2). Note that the user himself or herself may set the physical activity level. However, a mentor or the like who is in a position of giving an advice to the user may set the physical activity level through an interview or the like with the user.

4. Flow of Processing in this Embodiment

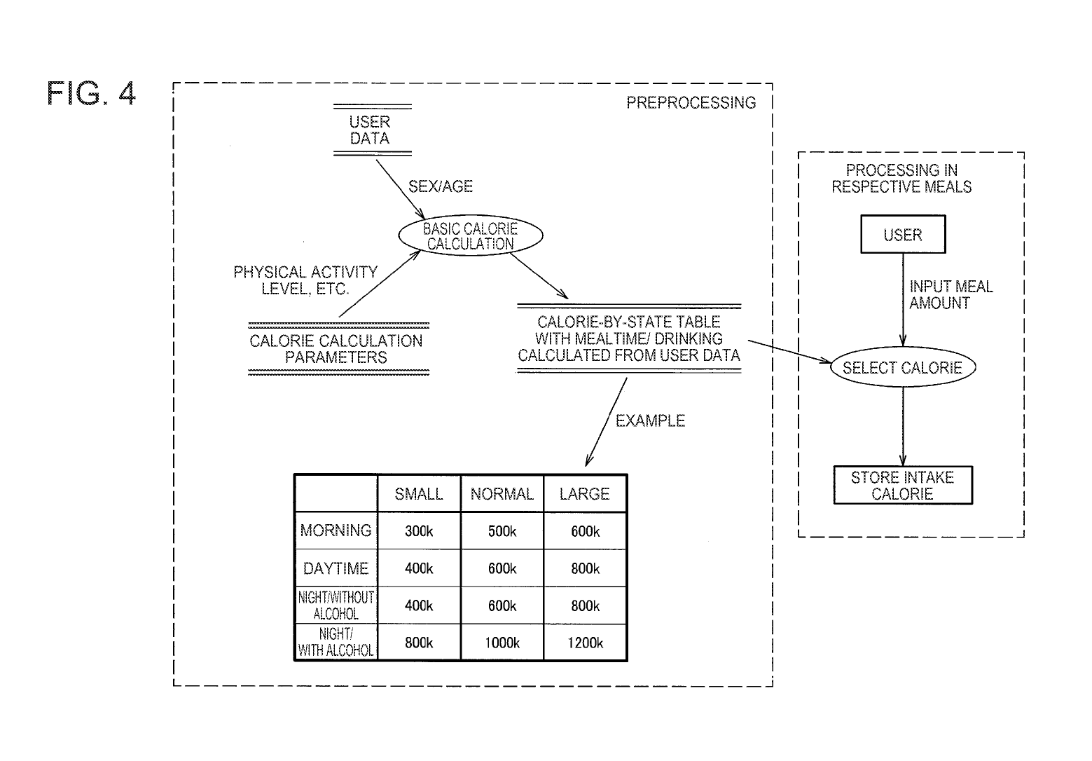

A flow of processing in this embodiment is explained with reference to FIG. 4 to FIG. 11. Specifically, after a flow of overall processing is explained, a flow of processing applied to meals (processing in a “meal mode” explained below) is explained. A modification of the processing in the meal mode is also explained.

### 4.1. Flow of the Overall Processing

First, an overall processing flow is explained with reference to FIG. 4. In this embodiment, personal data of the user is acquired in a pre-stage of calculation of an intake calorie amount by a meal. Specifically, as shown in FIG. 4, information concerning sex, age, and physical activity level is acquired. Note that information concerning weight and height may be included in the user data. Consequently, it is possible to calculate beforehand a calorie amount necessary in one day using the above Expression (1). This does not prevent the calculation of the above Expression (1) from being performed every time in the calculation of a calorie amount by a meal. However, a processing load can be reduced by performing the pre-calculation.

Meal coefficients cannot be determined unless mealtimes and meal amount information of meals are determined. However, it is assumed that the number of meal coefficients is limited to a certain degree. For example, as shown in FIG. 3, when there are four kinds of morning, daytime, night, and others as the mealtimes and there are three kinds of “large”, “normal”, and “small” as the meal amount information, there are twelve kinds of meal coefficients. That is, the calorie amount by a meal calculated by the above Expression (2) is also limited to twelve kinds. Therefore, rather than performing the calculation of the Expression (2) every time, twelve kinds of calorie amounts may be calculated beforehand and, when the mealtime and the meal amount information are input, the corresponding value may be selected from the twelve kinds of calorie amounts.

For example, a calorie-by-state table shown in FIG. 4 is calculated beforehand from the personal data of the user and the meal coefficients and one value is selected out of the calorie-by-state table. Consequently, when a mealtime is discriminated by the discrimination processing in the discriminating unit 140 and meal amount information is determined in the processing unit 150 according to the information received from the input-information acquiring unit 110, if one corresponding value is selected from the calorie-by-state table shown in FIG. 4, the selected value can be used as a calorie amount corresponding to the meal. Therefore, it is unnecessary to perform the calculation processing of the above Expressions (1) and (2) in the meals. It is possible to reduce a processing load in the calculation for calculating a calorie amount.

Note that, as shown in the calorie-by-state table shown in FIG. 4, the meal amount information is not limited to information concerning the magnitude of an amount and may be information including presence or absence of drinking. When the drinking is performed, a calorie amount of alcohol itself cannot be ignored. It is possible that the user unconsciously increase a meal amount according to an effect of the alcohol. That is, in the case of presence of the drinking, it is conceivable that an intake calorie amount is large compared with the case of absence of the drinking. The increase in the intake calorie may be taken into account by including presence or absence of alcohol in the meal amount information. In this case, although not shown in FIG. 3, it is necessary to separately set meal coefficients in the case of the drinking.

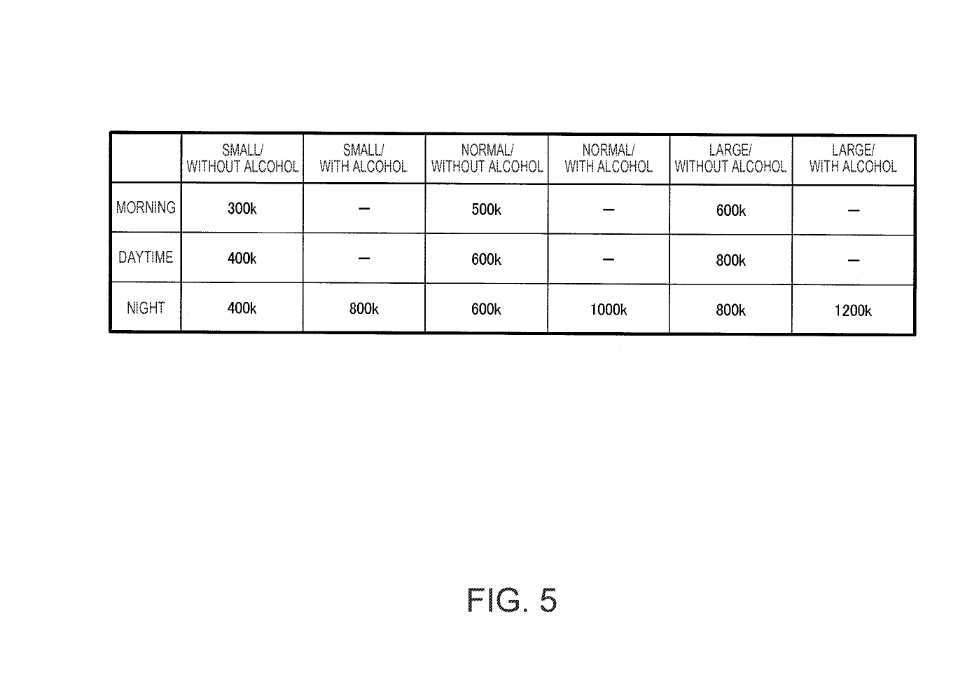

In the calorie-by-state table shown in FIG. 4, for convenience of creation of the table, it looks as if presence or absence of alcohol is included in the information concerning the mealtime. However, a calorie-by-state table conforming to processing is as shown in FIG. 5. That is, in the meal amount information, there are six kinds of items including three kinds of “small”, “normal”, and “large” concerning the magnitude of the amount and two kinds concerning the presence or absence of alcohol. Intake calorie amounts corresponding to the mealtimes of morning, daytime, and night are set concerning each of the items. Note that, in a dietary habit in our country, drinking is rarely performed in breakfast and lunch. Therefore, only an intake calorie amount during dinner is calculated concerning meal amount information “with alcohol”. When drinking is performed, the intake calorie amount of the calorie-by-state table is multiplied by a predetermined rate, for example, 1.2 to calculate an intake calorie amount corresponding to the drinking.

Summarizing the above points, the overall processing in this embodiment has a flow of performing preprocessing for, for example, determining the calorie-by-state table shown in FIG. 4 or FIG. 5 and then repeatedly executing “processing performed in meals” shown on the right side of FIG. 4 by the number of times equivalent to the number of times of meals. Note that it is also likely that the calorie-by-state table should be updated, for example, when the physical activity level changes according to a change in a lifestyle. Therefore, the preprocessing is not limited to once and may be performed a plurality of times according to necessity.

Note that, as indicated by the above Expression (1), information concerning the weight of the user is also necessary for the creation of the calorie-by-state table. A value of the weight of the user fluctuates. However, as explained above, it is sufficiently conceivable that the calorie amount calculated in this embodiment is used for weight control of the user. Therefore, it is highly possible that the electronic apparatus in this embodiment acquires the information concerning the weight of the user at a predetermined frequency. Therefore, in this embodiment, the preprocessing (update processing for the calorie-by-state table) may be performed according to, for example, acquisition timing of the information concerning the weight of the user. However, since fluctuation of a value of measured weight is large, only one value is sometimes unlikely to match a changing tendency of the weight of the user. For example, even when the weight tends to decrease, it is conceivable that a large weight value is temporarily acquired. In that case, although an energy amount necessary in one day tends to decrease, it is likely to be determined due to using the large weight value that an excessive energy amount is necessary. Therefore, a method of, for example, calculating a regression line or the like using a plurality of measurement values of the weight and setting, as the weight value of the above Expression (1), a correction value determined by the regression line or the like may be used. It is possible to implement various modifications concerning this point.

### 4. 2. Processing Performed in Respective Meals

Processing performed for respective meals is explained. Specifically, the processing is processing for determining a mealtime and meal amount information and calculating an intake calorie amount by the meal.

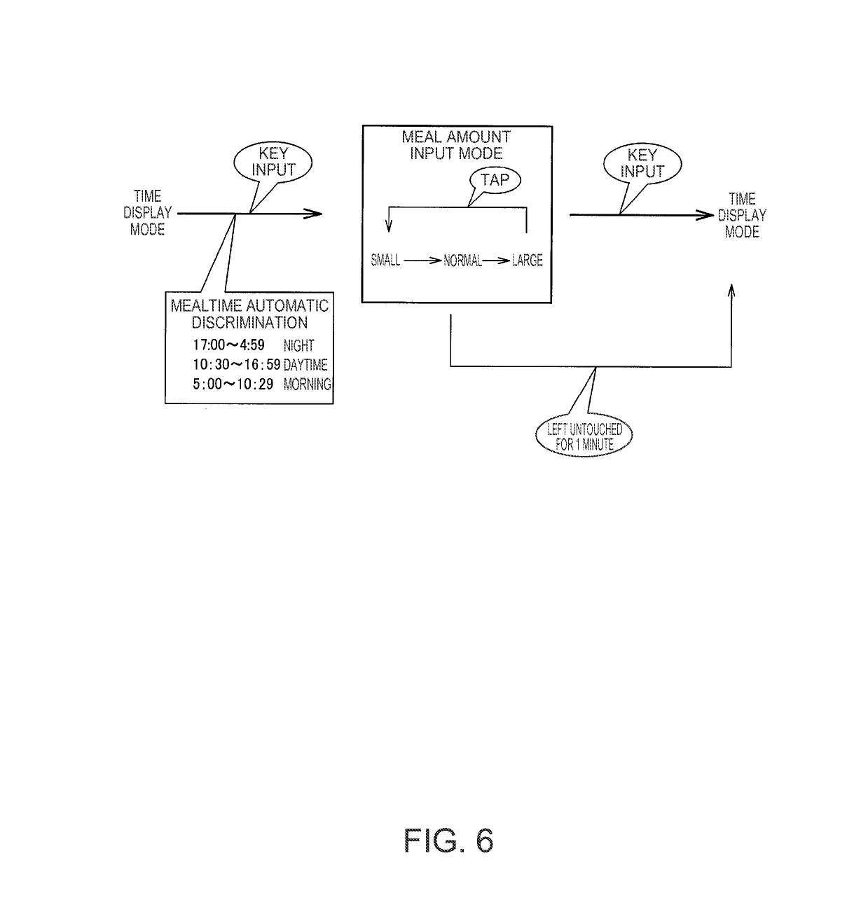

Transition of an operation mode of the electronic apparatus and an example of input operation in the processing performed for the meals in this embodiment are shown in FIG. 6.

The electronic apparatus in this embodiment inputs information concerning a meal. However, the electronic apparatus may have other functions. For example, by displaying date and time as shown in FIG. 12, the electronic apparatus can also be used like a normal watch. In that case, the electronic apparatus in this embodiment has at least two operation modes, i.e., an information display mode for displaying some information such as time and a meal mode for performing the input concerning a meal explained above. The processing unit 150 of the electronic apparatus may perform mode switching processing for switching the operation mode of the electronic apparatus. When the operation mode is switched, switching of a display image is also performed accordingly.

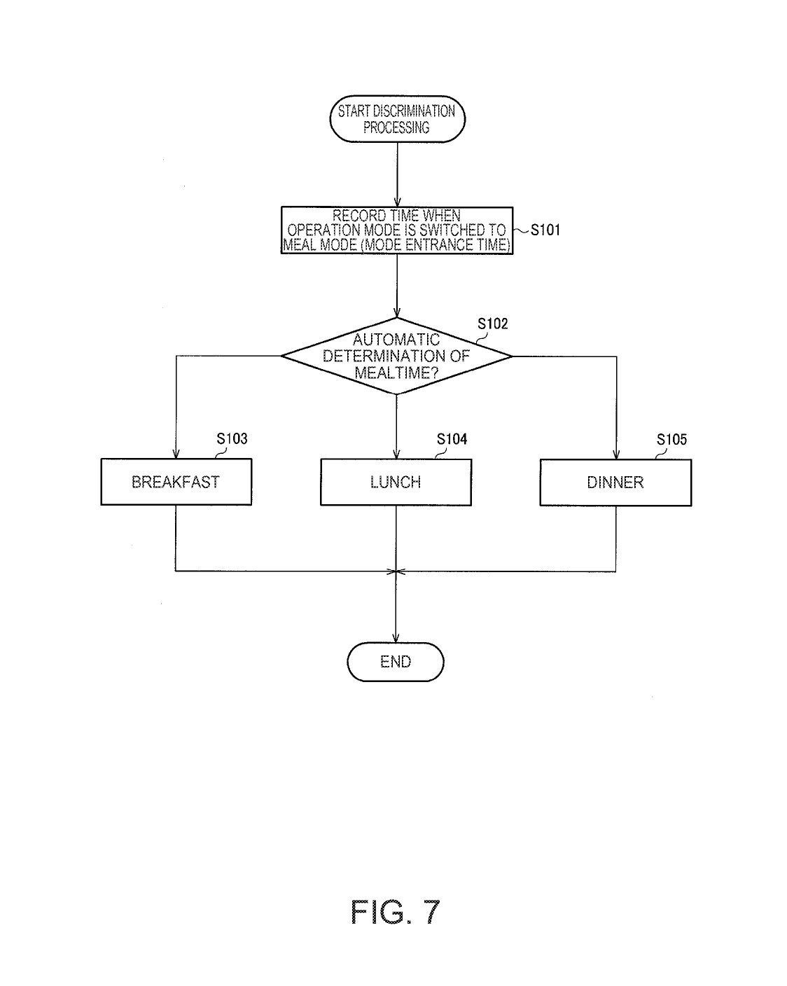

The discrimination processing in the discriminating unit 140 is performed, for example, on the basis of time information at timing when the operation mode is switched from the information display mode to the meal mode. A flow of the discrimination processing in the discriminating unit 140 is shown in a flowchart of FIG. 7. The discriminating unit 140 acquires, from the time-information acquiring unit 120, time information corresponding to timing when the operation mode of the electronic apparatus is switched from another mode (in a narrow sense, the information display mode) to the meal mode (S101). Alternatively, the discriminating unit 140 may perform the discrimination processing on the basis of time information at timing when the electronic apparatus enters the meal mode and selection operation is performed in the meal mode. The discriminating unit 140 performs automatic discrimination of a mealtime on the basis of the acquired time information (S102). For example, when time at timing when the operation mode is switched to the meal mode is acquired as the meal information, the discriminating unit 140 only has to perform comparison processing between the time and reference periods of time. As an example, as shown in FIG. 6, when the reference periods of time are set to determine 5:00 to 10:29 as breakfast, determine 10:30 to 16:59 as lunch, and determine 17:00 to 4:59 as dinner, the discriminating unit 140 discriminates to which period of time the time acquired from the time-information acquiring unit 120 belongs and outputs a mealtime corresponding to the period of time to which the time belongs. In the example of the reference periods of time, if time 8:00 is acquired, it is discriminated that the time is for breakfast (corresponding to S103), if time 12:00 is acquired, it is discriminated that the time is for lunch (corresponding to S104), and, if time 19:00 is acquired, it is discriminated that the time is for dinner (corresponding to S105).

However, the reference periods of time are not limited to the example explained above. For example, as indicated by the meal coefficients shown in FIG. 3, an item “others” indicating mealtimes other than breakfast, lunch, and dinner may be used. This is equivalent to, for example, eating between meals and sets reference periods of time for determining lunch as 10:30 to 14:59 and determining 15:00 to 16:59 as eating between meals.

Alternatively, the reference periods of time may be set for each user. In the meal coefficients shown in FIG. 3, according to the idea that an intake calorie amount is larger in a normal amount of lunch than a normal amount of breakfast as explained above, the meal coefficient of normal lunch is set larger than the meal coefficient of normal breakfast. That is, “breakfast” in FIG. 3 represents a meal considered to have a relatively small intake calorie amount in one day. An intake time of the “breakfast” does not always need to be a period of time considered to be morning. For example, a night shift user sometimes wakes up and takes a first meal in one day in the afternoon (e.g., 13:00). In that case, in the reference periods of time explained above, the meal corresponds to lunch. However, for the night shift user, the meal ought to be a relatively small intake calorie in one day. That is, for the user, even if the meal at 13:00 is temporally in daytime but corresponds to “breakfast”. To cope with such a difference among users, in the discrimination processing in the discriminating unit 140, it is desirable to use reference periods of time set taking into account a life cycle and the like of the user as well.

A mealtime is automatically discriminated by the discrimination processing in the discriminating unit 140 explained above. Therefore, thereafter, if an input of meal amount information is performed by the user, an intake calorie amount can be determined. Therefore, when the operation mode of the electronic apparatus transitions to the meal mode according to a key input for instructing the mode switching processing from the information display mode as shown in FIG. 6, a meal amount input mode for inputting a meal amount has only to be executed.

Various input interfaces for meal amount information are conceivable. For example, as shown in FIG. 6, a selected state of meal amounts, i.e., small, normal, and large, may be switched by the tap operation. For example, in a state in which “small” is selected as the meal amount information, when an input by one tap operation is acquired by the input-information acquiring unit 110, the discriminating unit 140 sets “normal” in a selected state as the meal amount information. Similarly, when the tap operation is received in a state in which “normal” is selected, the discriminating unit 140 transitions the meal amount in the selected state to “large”. When the tap operation is received in a state of “large”, the discriminating unit 140 returns the meal amount in the selected state to “small”. When operation other than the tap operation such as key operation is performed, the discriminating unit 140 decides the meal amount in the selected state, determines an intake calorie amount corresponding to the meal amount, stores the intake calorie amount, and returns to the information display mode.

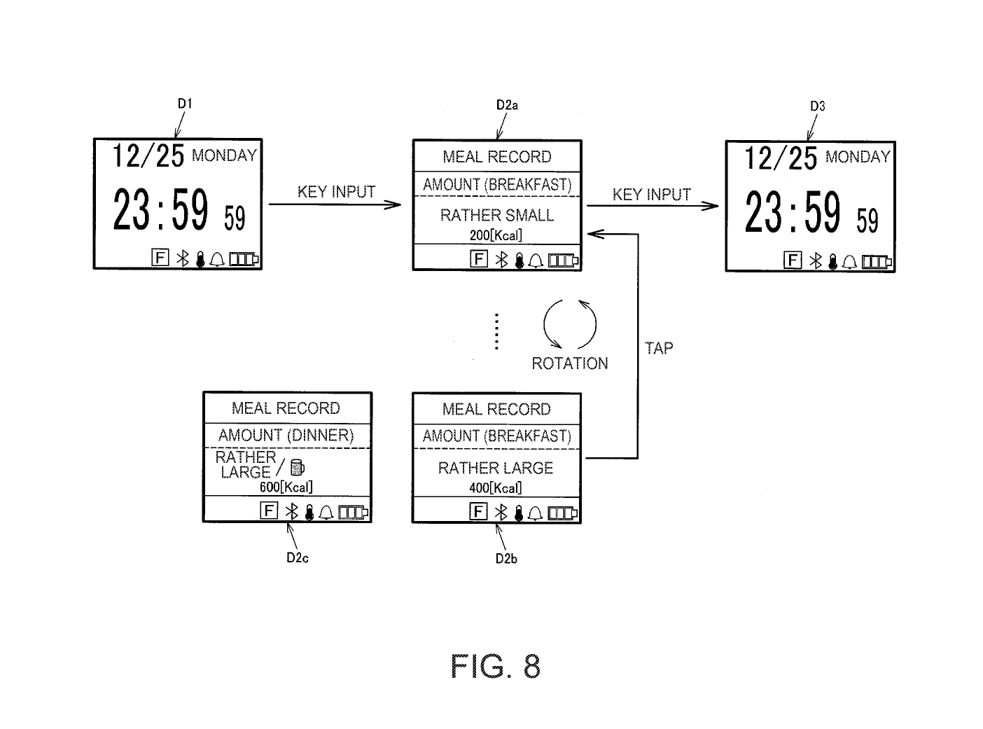

An example of a screen transition of the interface explained above is FIG. 8. D1 in FIG. 8 is an example of a display image in the information display mode. Information such as date, time, a battery residual capacity, and a network environment is displayed. In the information display mode for displaying D1, when the input-information acquiring unit 110 acquires information indicating that key operation is received, the processing unit 150 switches the operation mode to the meal mode and displays an information input screen on the display unit accordingly. The information input screen is, for example, a screen indicated by D2a. An information input concerning a meal amount is performed. As the meal amount, a plurality of input candidates “rather small”, “normal”, “rather large” are conceivable as explained above. Therefore, in the example shown in FIG. 8, the tap operation is received in this phase. Every time one tap operation is received, the meal amount in the selected state is transitioned and the display screen is transitioned according to the transition of the meal amount. For example, if meal amounts are two amounts “rather small” and “rather large”, screens of D2a and D2b have only to be alternately displayed every time the tap operation is performed. If there are three or more meal amounts, the meal amounts have only to be sequentially displayed. When the input-information acquiring unit 110 acquires, in the meal mode, information indicating that the key operation is received, the mode switching processing to the information display mode is performed as indicated by D3 (same as D1).

Note that, as explained above with reference to FIG. 5, the meal amount information may include presence or absence of drinking. In that case, in the input of the meal amount during the meal mode, not only transition of “small→normal→large” but also presence or absence of alcohol may be included. For example, six items “small (with alcohol)”, “small (without alcohol)”, “normal (with alcohol)”, “normal (without alcohol)”, “large (with alcohol)”, and “large (without alcohol)” may be used. Alternatively, assuming that likelihood of drinking in breakfast and lunch is low, the processing may be performed using three items “small”, “normal”, and “large” in breakfast and lunch and the processing may be performed using the six items in dinner. In this case, an image corresponding to the meal amount information including the presence or absence of drinking indicated by D2c in FIG. 8 is included in the screen transition.

The input interface for the meal amount information is not limited to the interface explained above. The input interface may be, for example, an interface for displaying a plurality of candidates of a meal amount in one screen or may be an interface that can change a given meal amount to any other meal amount to allow transition of the selected state from “small” to “large”. However, in the electronic apparatus of the wristwatch type shown in FIG. 12, it is highly possible that limitation on the area of the display unit and the numbers of buttons and keys provided in the operation unit is large. Therefore, when an information amount on one screen is large, a problem of visibility such as a decrease in the size of characters could occur. It is also possible that the number of buttons is insufficient for performing complicated operation. Therefore, in an electronic apparatus in which such limitation is large, the interface that uses the tap operation shown in FIG. 12 is useful.

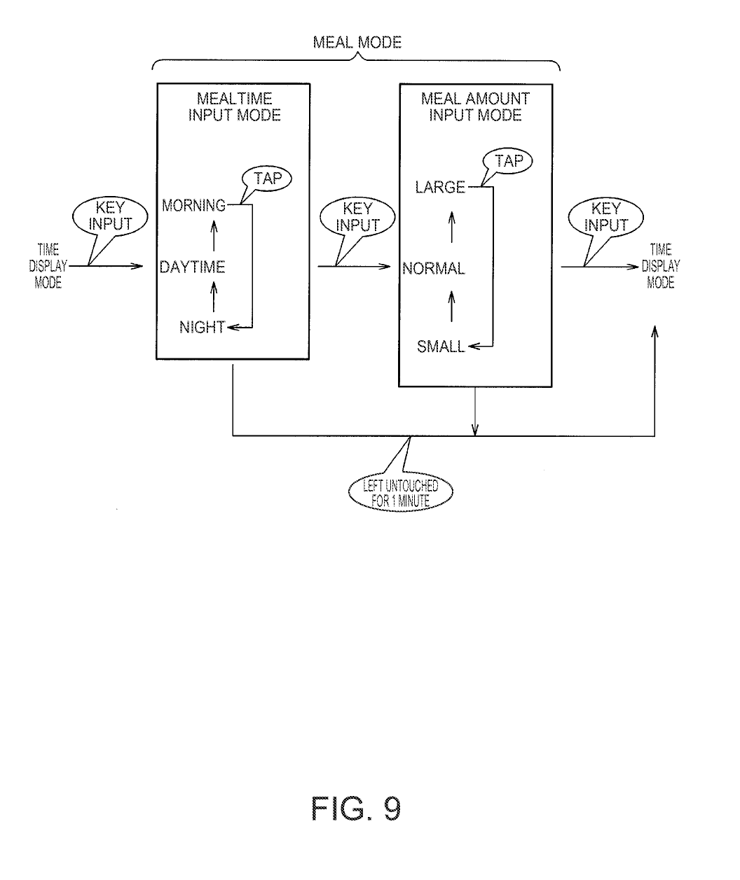

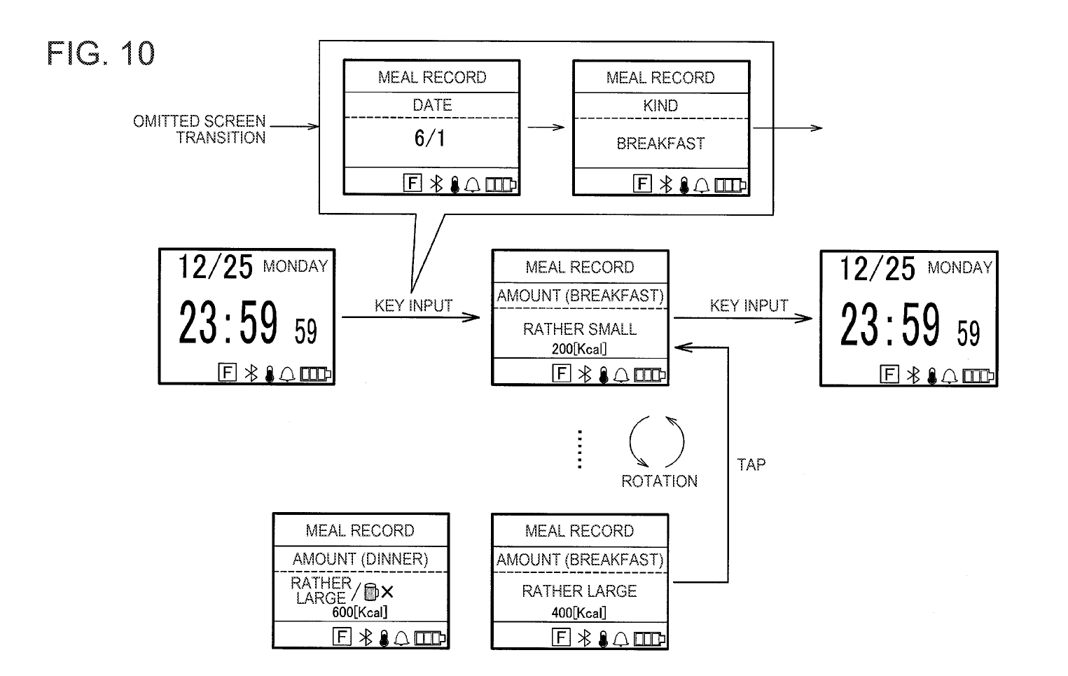

According to the method explained above, it is possible to skip the input concerning the mealtime. Therefore, it is possible for the user to record an intake calorie amount by a meal by performing an easy input. Comparison with the conventional method is shown in FIGS. 9 and 10. In the conventional method, when the operation mode transitions from the information display mode to the meal mode, first, it is necessary to perform an input concerning the mealtime. For example, as shown in FIG. 9, as the meal mode, there are two input modes, i.e., an input mode for a mealtime and an input mode for a meal amount. Selection and determination operation by the user are essential concerning each of the input modes. In this case, as shown as “omitted surface transition” in FIG. 10, the user is requested to input date and time of a meal and a specific mealtime. In that regard, in the method in this embodiment, an input step concerning the mealtime can be omitted. Therefore, it is possible to reduce a burden concerning an input by the user.

### 4.3. Modification

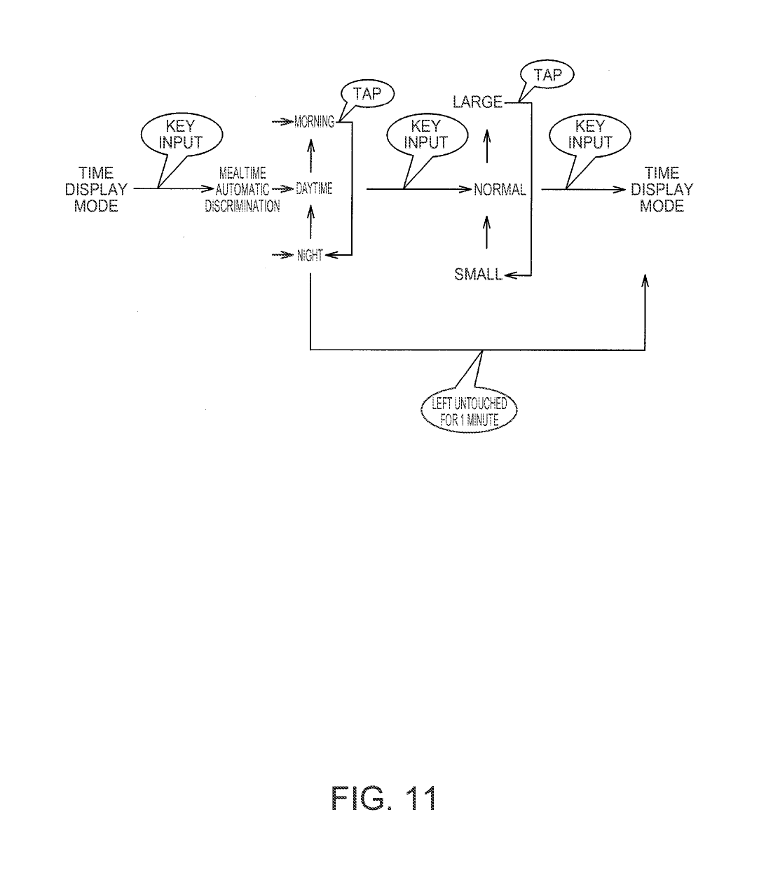

The input method in the meal mode is not limited to FIG. 6 and FIG. 8. In FIG. 6, the mealtime is decided according to the result of the discrimination processing by the discriminating unit 140. However, as shown in FIG. 11, a form may be adopted in which an initial selected state in the mealtime input mode is set on the basis of the result of the discrimination processing and thereafter a change or the like by the user is permitted.

For example, it is assumed that the discriminating unit 140 discriminates that the mealtime is lunch. In that case, in FIG. 6, all user inputs concerning the mealtime are skipped and the mealtime is decided as lunch. However, in an example shown in FIG. 11, although lunch is set as the initial selected state, the mealtime is not decided yet and a user input is received. If the discrimination processing is correct and an actual meal is also lunch, the user performs a key input without performing the selection operation for a mealtime to shift to the input mode for a meal amount. On the other hand, when there is an error in the discrimination processing, as in the transition of the meal amount explained above, the tap operation is performed and a user input for selecting correct mealtimes such as lunch→dinner→breakfast is performed.

Consequently, although the number of times of user inputs increases compared with the example shown in FIG. 6, when the discrimination processing is wrong, it is possible to correct the wrong discrimination processing. When the discrimination processing is correct, the mealtime in the initial selected state can be directly used. Therefore, as operation by the user, a key input has only to be performed once. That is, in many cases, a user input for a mealtime can be limited to one key input. Therefore, unlike the conventional method shown in FIG. 9, the selection operation is not a premise. It is possible to simplify the user input compared with the conventional method.

Note that, in the selection processing for meal amount information as well, it is possible to change the initial selected state. For example, a user aiming at an active weight loss is considered to often set a rather small meal amount. When an athlete or the like aims at improvement of physique, a rather large meal amount is considered to be often set. Alternatively, a user who already realized target weight is considered to maintain a normal meal amount. That is, it is possible to estimate a standard meal amount of the user from user data or the like. Therefore, meal amount information most highly possibly to be selected for a target user may be set as the initial selected state. For example, in the example shown in FIG. 11, the selected state of the meal amount=normal is set as the initial selected state. A meal amount with a high input frequency may be displayed as the initial selected screen.

### 5. Detection Method for the Tap Operation

As explained above, in the electronic apparatus limited in size and the like, the tap operation is a useful interface. The tap operation is operation for tapping the electronic apparatus. For example, in the electronic apparatus of the wristwatch type, the tap operation is operation for tapping the electronic apparatus with a hand opposite to a hand wearing the electronic apparatus as shown in FIG. 12. Note that, in FIG. 12, operation for tapping the electronic apparatus with a finger is shown. However, operation for tapping the electronic apparatus according to other methods such as using a palm is also included in the tap operation. However, to detect the tap operation, it is necessary to grasp an extremely short change of acceleration. Likelihood of misdetection increases unless sampling of an acceleration signal is performed at resolution of, for example, about 200 Hz. However, when the resolution is set fine, power consumption increases. That is, the detection accuracy of the tap operation and the power consumption are in an inverse proportion relation. It is difficult to find a good balance of usability and an apparatus battery life.

Therefore, the applicant proposes a method of appropriately controlling, by setting a sampling frequency taking likelihood of the tap operation to be performed into account, the detection accuracy of the tap operation and power consumption required for the detection of the tap operation. Specifically, the sampling frequency is set according to operation information, a reception state of a communication unit, and the like. Consequently, it is possible to perform setting of the acceleration sensor more suitable for the tap operation.

### 5.1 System Configuration Example

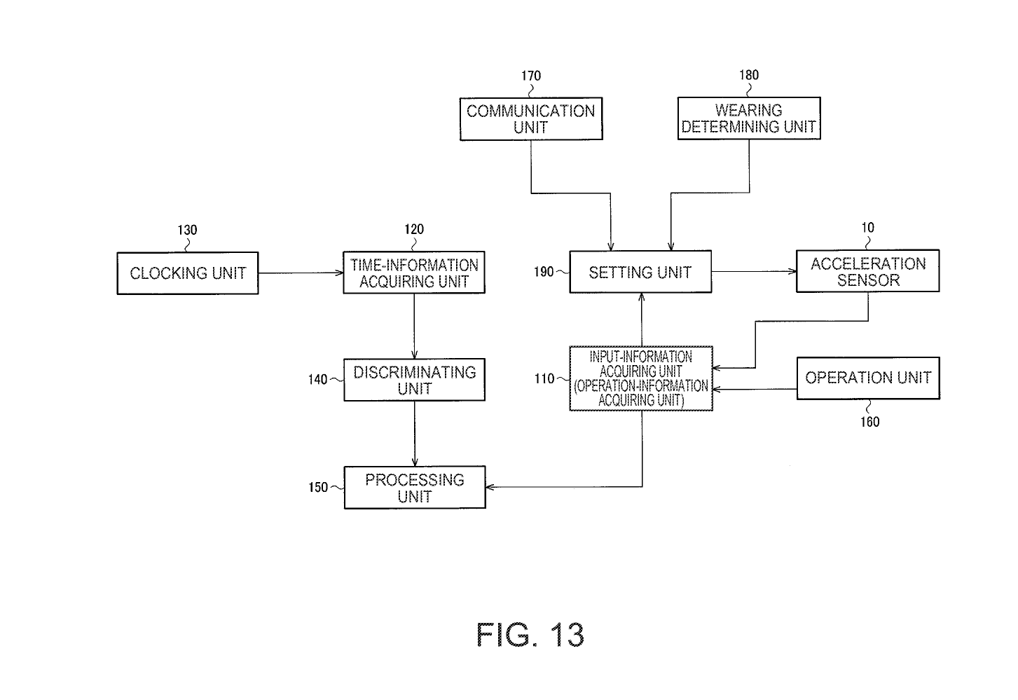

In FIG. 13, a configuration example of the electronic apparatus in this embodiment in which the sampling frequency is variably set is shown. When compared with FIG. 1, the electronic apparatus has a configuration in which an acceleration sensor 10, an operation unit 160, a communication unit 170, a wearing determining unit 180, and a setting unit 190 are added. Note that detailed explanation is omitted concerning components same as the components shown in FIG. 1.

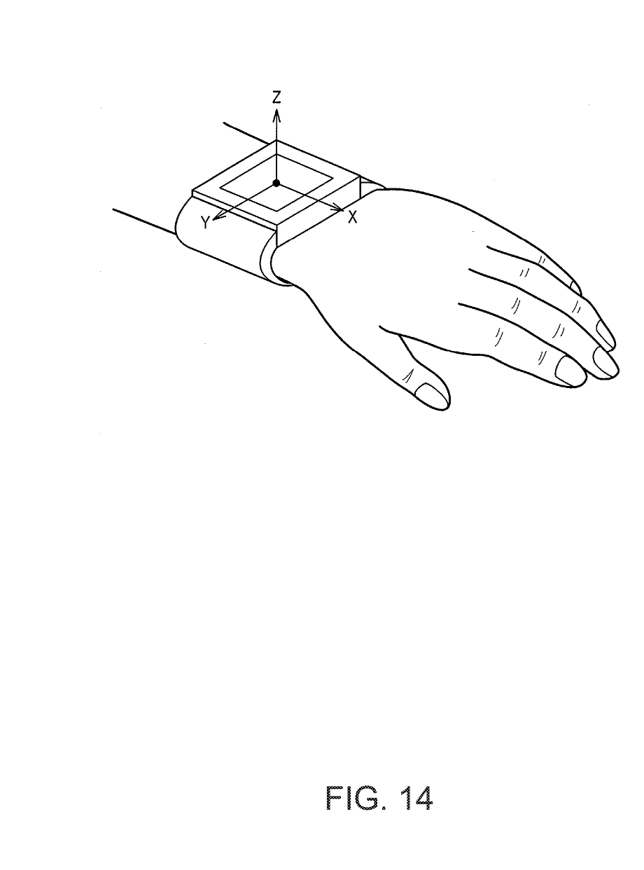

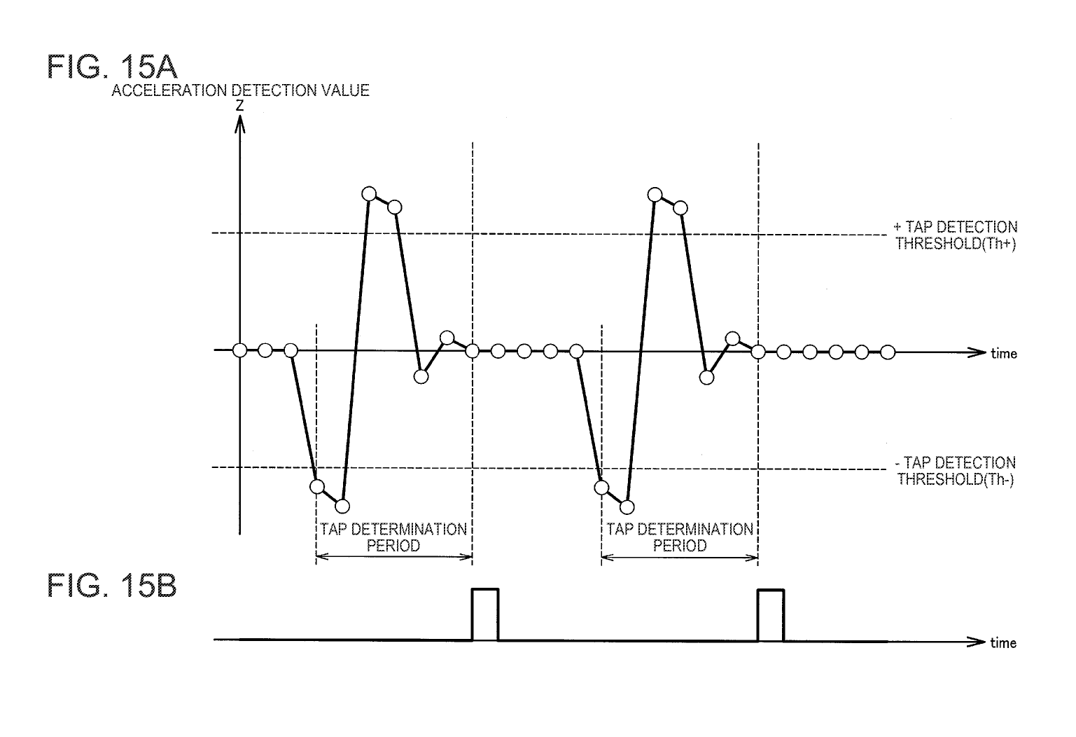

The acceleration sensor 10 is a sensor that acquires information concerning acceleration. The acceleration sensor 10 may be, for example, a three-axis acceleration sensor. More specifically, the acceleration sensor 10 may be a sensor that is provided in the electronic apparatus of the wristwatch type and detects acceleration values in respective axes of an X axis, a Y axis, and a Z axis shown in FIG. 14. A specific example of an acceleration detection value in a given axis is as explained below with reference to FIG. 15(A). However, the acceleration sensor 10 in this embodiment is not limited to an acceleration sensor that directly outputs values shown in FIG. 15(A) and the like. The acceleration sensor 10 may be an acceleration sensor that performs detection processing for the tap operation on the basis of the values shown in FIG. 15(A) and parameters set by the setting unit 190 explained below. Note that a result of the detection processing for the tap operation is considered to be a pulse waveform in which a signal rises at timing corresponding to detection timing, for example, as shown in FIG. 15(B).

The operation unit 160 represents a user interface such as a button, a key, or a touch panel. The tap operation explained here is not included in operation by the operation unit 160. As explained above, the input-information acquiring unit 110 acquires information based on the operation of the operation unit 160 and the tap operation based on the information received from the acceleration sensor 10.

The communication unit 170 performs communication processing for information with other electronic apparatuses and the like via a network. The network may be either a wired network or a wireless network. For example, when the electronic apparatus in this embodiment is a wristwatch type device, it is conceivable that the wristwatch type device and a smart phone or the like are connected via a network such as a short-range radio and operate in association with each other while performing communication of information. The communication unit 170 functions as an interface in that case. The communication unit 170 acquires, from the smart phone, for example, information concerning operation of the smart phone by the user, reception of information by the smart phone, and the like.

The wearing determining unit 180 determines a worn state of the electronic apparatus and outputs a determination result to the setting unit 190. For example, when a light receiving unit is included in the electronic apparatus, the wearing determination has only to be performed on the basis of a light amount detected by the light receiving unit. If the light receiving unit is provided in a rear portion of a dial of the watch type device, whereas the light amount decreases in a worn state because external light is blocked, the light amount increases in an unworn state because the external light is also detected. Therefore, it is possible to perform the wearing determination on the basis of the light amount detected by the light receiving unit. However, other methods may be used for the wearing determination. It is possible to implement various modifications. As an example, the acceleration detection value in the acceleration sensor 10 may be used. For example, whereas large values by walking and arm swinging are detected during the wearing, values other than the gravitational acceleration are hardly detected when the electronic apparatus is left untouched on a desk or the like in the unworn state. Therefore, the wearing determination may be performed on the basis of this difference.

The setting unit 190 performs setting of parameters in the detection processing for the tap operation using the acceleration sensor 10 on the basis of the information received from the input-information acquiring unit 110, the communication unit 170, the wearing determining unit 180, and the like. Specifically, the setting unit 190 sets a sampling frequency and a threshold of an acceleration signal. Details of setting processing in the setting unit 190 are explained below.

### 5.2 Basic Method of Tap Detection

A basic method of detecting the tap operation on the basis of the acceleration detection value detected by the acceleration sensor 10 is explained. A tapping action shown in FIG. 12 is performed in the tap operation. Therefore, a shock due to the action is detected by the acceleration sensor 10.

It has been found that the shock due to the tapping action is detected as up-down movements of a signal waveform as shown in FIG. 15(A) in the acceleration detection value of the acceleration sensor 10. Therefore, in this embodiment, the detection of the tap operation is performed on the basis of comparison processing of a signal value in the downward direction and a threshold, comparison processing of a signal value in the upward direction and a threshold, or both the kinds of comparison processing.

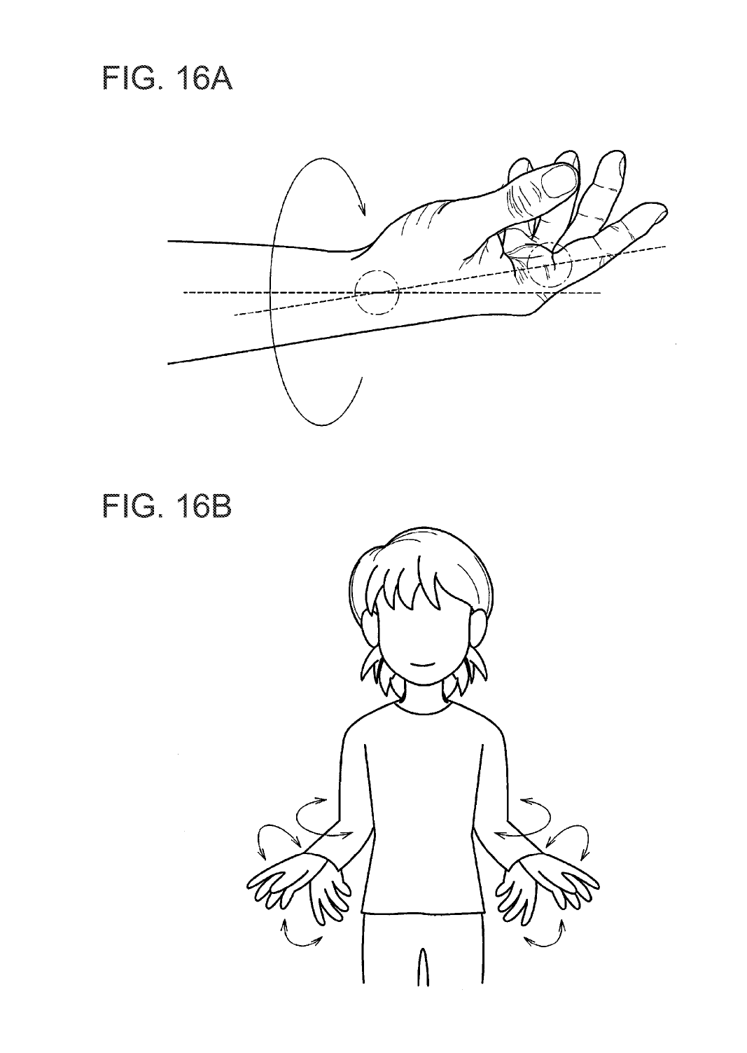

However, besides the tap operation, there are actions in which changes in acceleration appear upward and downward. Specifically, the actions are a turning action of a wrist shown in FIG. 16(A) and a swinging action of the wrist shown in FIG. 16(B).

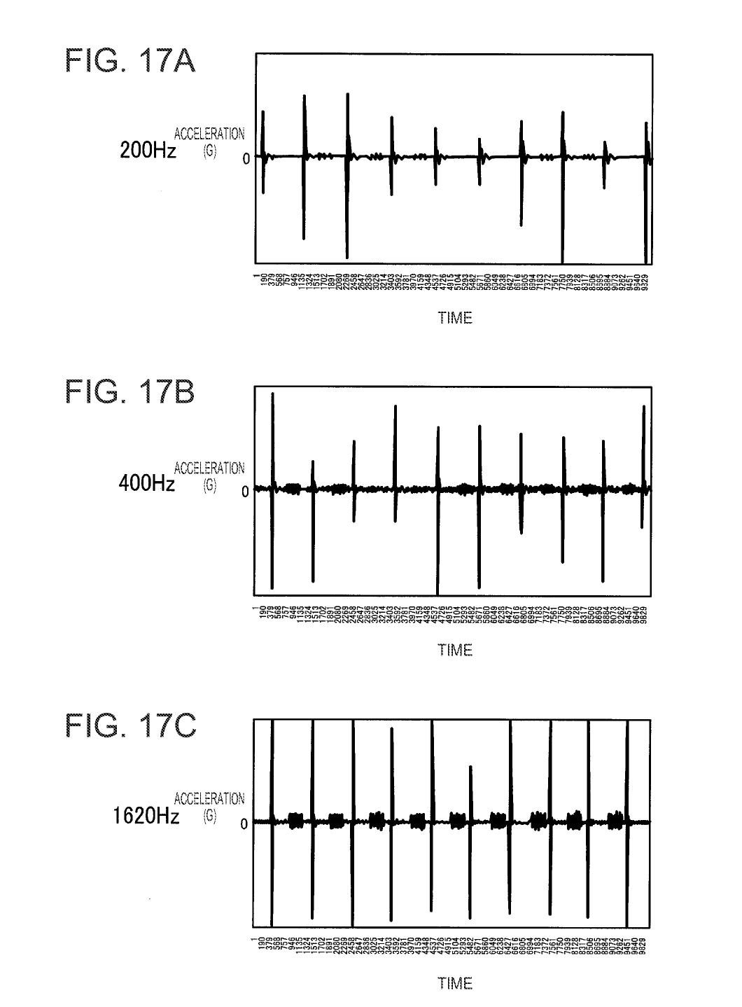

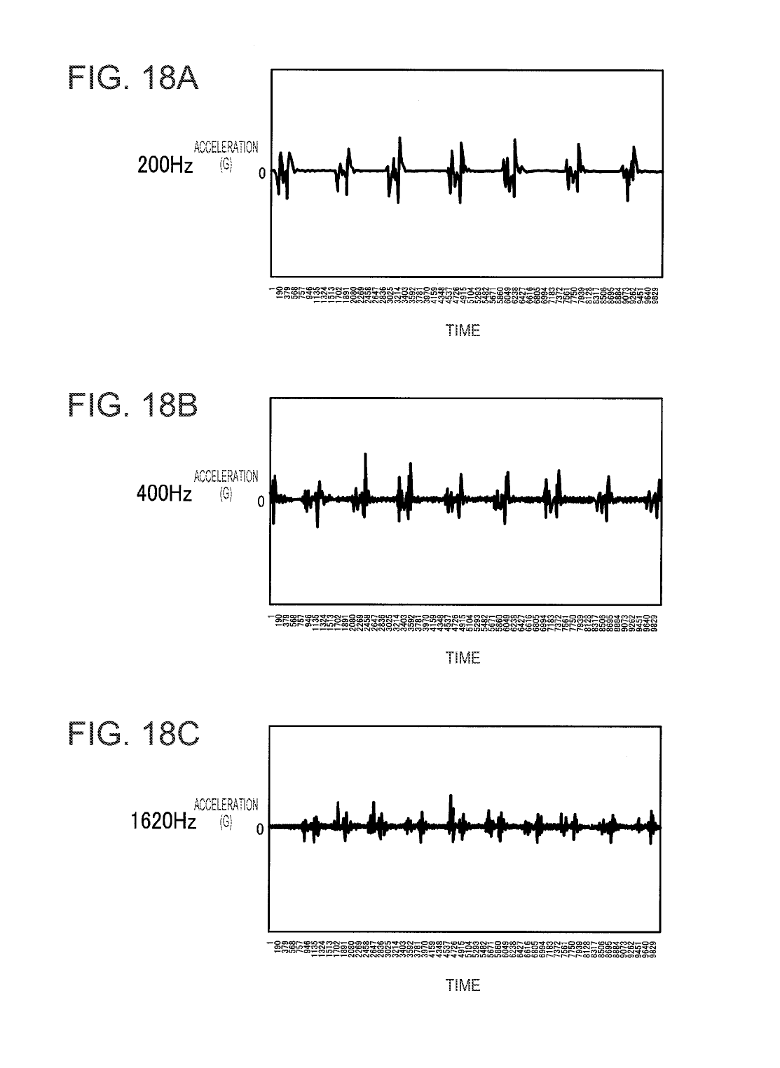

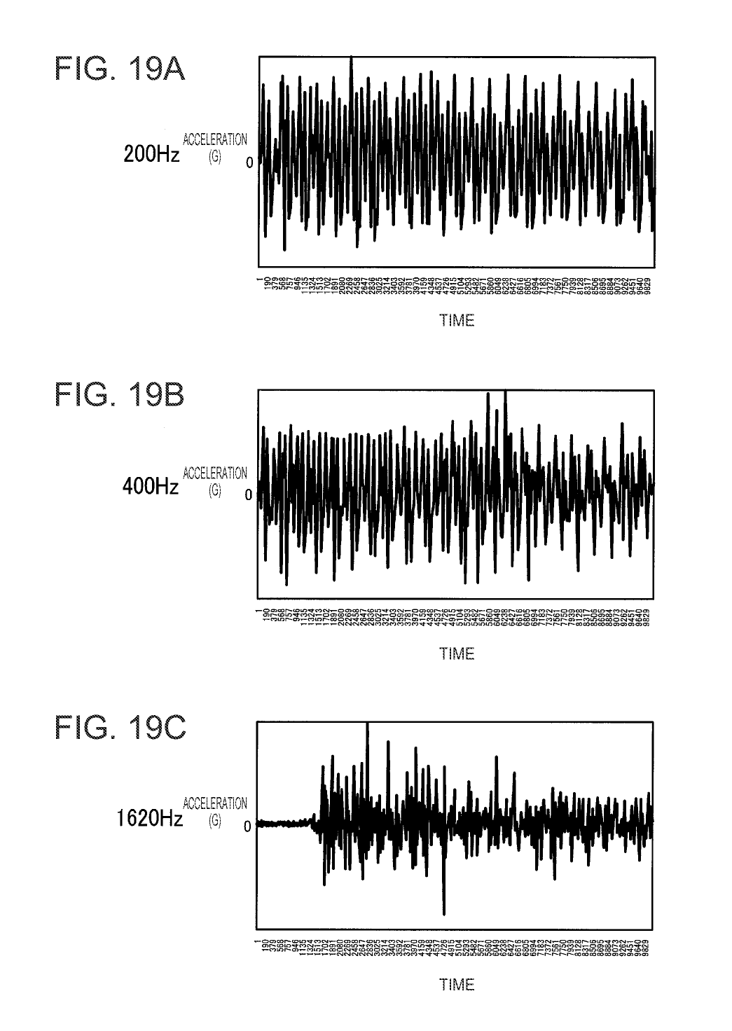

In FIG. 17(A) to FIG. 17(C), changes in acceleration detection values of the tap operation at different sampling frequencies are shown. Specific sampling frequencies are 200 Hz in FIG. 17(A), 400 Hz in FIG. 17(B), and 1620 Hz in FIG. 17(C). The same applies in FIG. 18(A) to FIG. 18(C) and FIG. 19(A) to FIG. 19(C). FIG. 18(A) to FIG. 18(C) are changes in acceleration detection values of the turning action of the wrist. FIG. 19(A) to FIG. 19(C) are changes in acceleration detection values of the swinging action of the wrist. As it is seen from FIG. 17(A) to FIG. 19(C), all points where the acceleration detection values change upward and downward are the same. Therefore, to accurately detect the tap operation, it is necessary to appropriately distinguish the turning action of the wrist, the swinging action of the wrist, and the tap operation.

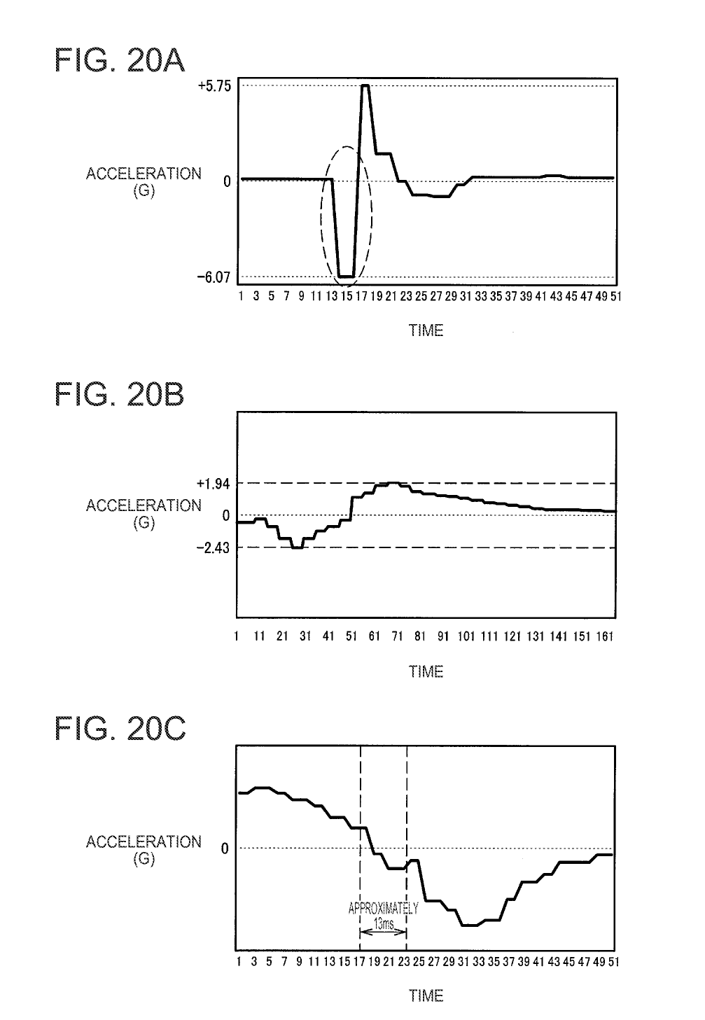

Respective acceleration changes in a relatively short period of the tap operation, the turning action of the wrist, and the swinging action of the wrist are shown in FIG. 20(A) to FIG. 20(C). A sampling frequency in FIG. 20(A) to FIG. 20(C) is set to 400 Hz.

FIG. 20(A) is a waveform of the acceleration detection value by the tap operation. It is seen that the width of the up-down movement of acceleration is approximately −6 G to +5.7 G in the tap operation. Note that, in the following explanation, it is assumed that an acceleration value in a state in which the tap operation is not performed is 0 G. As it is seen from a region surrounded by a dotted line in FIG. 20(A), a change in the acceleration in one direction is length of approximately 10 to 13 ms. One cycle of the up-down movement is length of approximately 20 to 26 ms.

When compared with a waveform change of the turning action of the wrist shown in FIG. 20(B) in view of this point, in the turning action of the wrist, the width of the up-down movement is relatively small and is approximately −2.4 G to +1.9 G. That is, in determination in a negative direction, a threshold is provided between −6 G and −2.4 G. In determination in a positive direction, the threshold is provided between +1.9 G to +5.7 G. Consequently, it can be said that it is possible to distinguish the tap operation and the turning action of the wrist on the basis of comparison processing of the threshold and the acceleration detection value.

On the other hand, when the tap operation is compared with a waveform change of the swinging action of the wrist shown in FIG. 20(C), the width of the up-down movement of the acceleration detection value is slightly larger in the tap operation. However, a difference between values is small compared with the comparison of the tap operation and the turning action of the wrist. It can be said that highly accurate distinction is difficult in the determination by the threshold. However, as it is seen from comparison of FIGS. 20(A) and 20(C) in which scales of the abscissa (time) are set the same, a cycle of a waveform of the swinging action of the wrist is extremely long compared with the tap operation. As explained above, a half cycle is approximately 10 to 13 ms in the tap operation. Therefore, it is possible to calculate a value equivalent to the amplitude of the waveform by using a signal value within 10 to 13 ms. On the other hand, in the swinging action of the wrist, as shown in FIG. 20(C), even if the signal value within 10 to 13 ms is used, a change in the signal value is extremely small in that period. A value equivalent to the amplitude cannot be acquired. That is, the waveform used in the detection of the tap operation is set to 10 to 13 ms (in a broad sense, a given period set on the basis of the cycle of the waveform of the tap operation). Consequently, it can be said that it is possible to appropriately distinguish the tap operation and the swinging operation of the wrist.

According to the above explanation, by appropriately setting the period and the threshold used for the detection of the tap operation, it is possible to detect the tap operation without confusing the tap operation with a similar action.

As explained above, in the detection of the tap operation, in order to distinguish the tap operation from the swinging action of the wrist, a waveform in a given period set on the basis of a cycle of a waveform of the tap operation is set as a processing target. In that case, when the sampling frequency is set too low, it is possible that no signal can be acquired in the period. The comparison processing with the threshold cannot be performed in the first place. For example, when a sampling frequency equal to or lower than 100 Hz, which is a frequency corresponding to 10 ms, is used, when a certain period of 10 ms is set as a target, the sampling frequency is inappropriate because it is possible that no signal value is acquired in the target period.

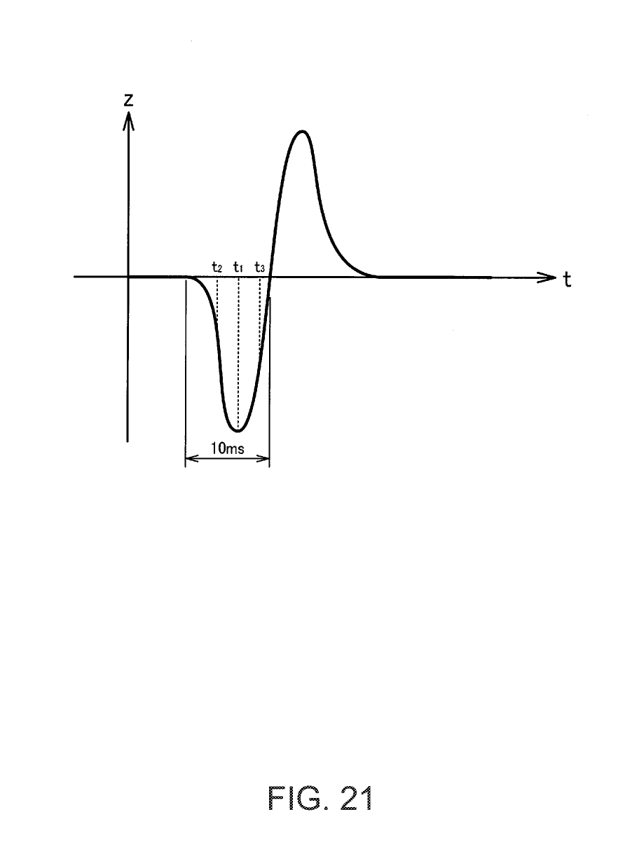

The range of the acceleration detection value in the tap operation, i.e., approximately −6 G to +5.7 G, explained above with reference to FIG. 20(A) corresponds to a minimum value and a maximum value (or values close thereto) of the up-down movement of the waveform. Therefore, when the sampling frequency is low and acceleration at timing corresponding to the minimum value or the maximum value is not acquired as the acceleration detection value, the acceleration detection value detected by the acceleration sensor 10 is small compared with acceleration inherent in the shock due to the tap operation. For example, when an acceleration waveform inherent in the tap operation is as shown in FIG. 21, only one value can be acquired within 10 ms at the sampling frequency of approximately 100 Hz. Therefore, if timing indicated by t1 is sampling timing, desired processing can be performed. However, when timing of t2, t3, or the like is the sampling timing, the acceleration detection value decreases. As a result, the possibility cannot be denied that the acceleration detection value due to the tap operation is smaller than approximately −2.4 G to +1.9 G, which is a change width of the acceleration detection value of the turning action of the wrist. In that case, in the above described determination processing using the threshold, the tap operation cannot be detected.

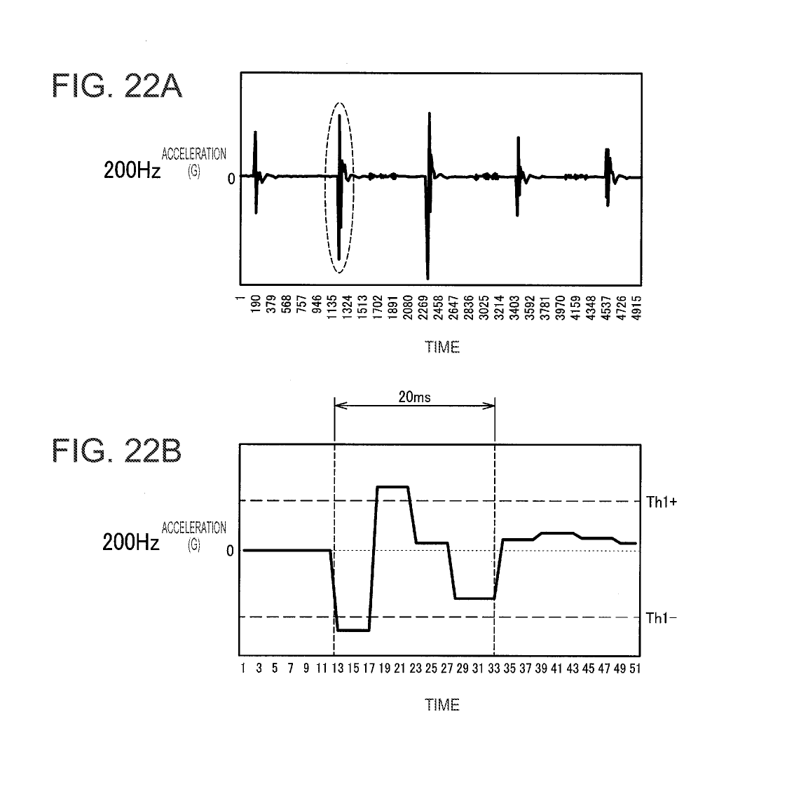

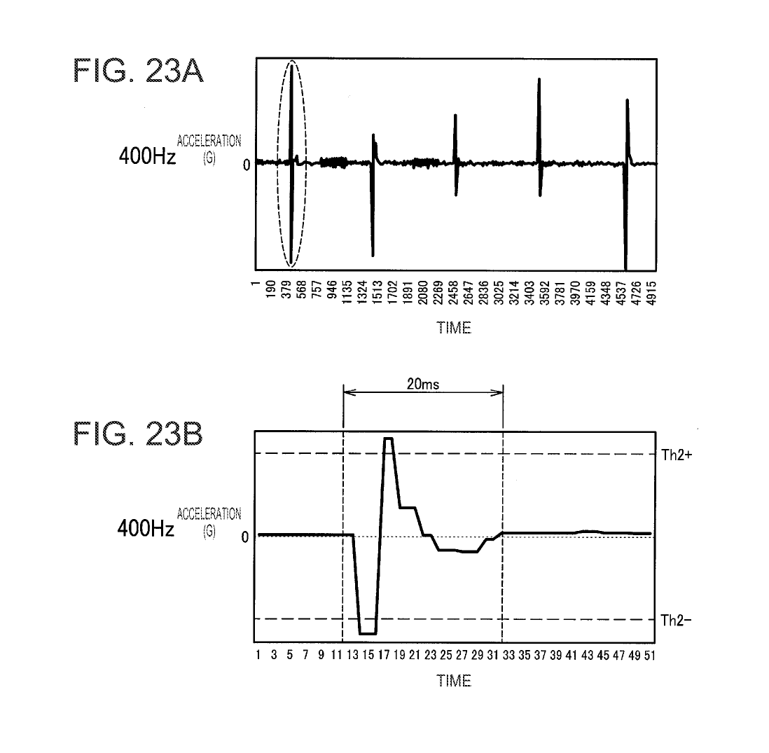

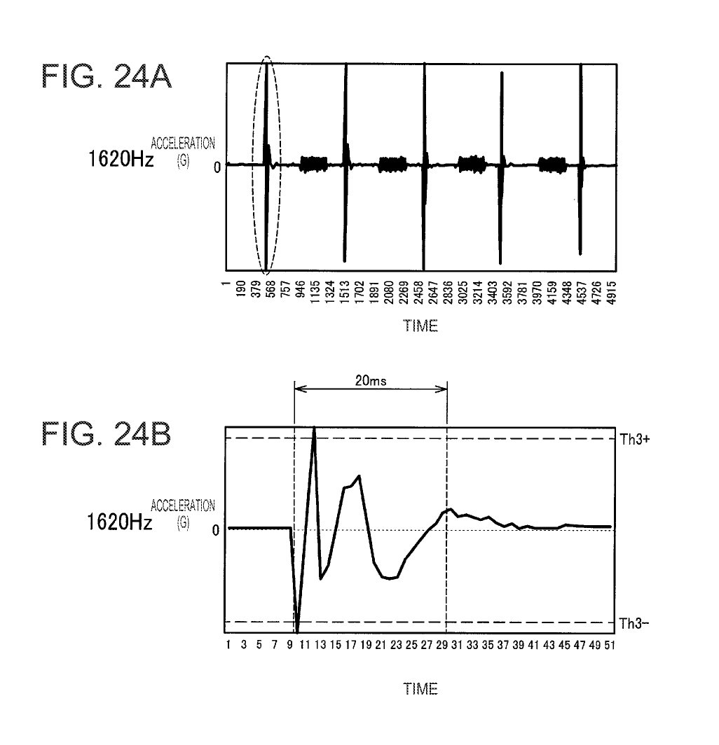

That is, the detection accuracy of the tap operation depends on the possibility that a vertex of a signal waveform or a value close to the vertex can be sampled. In other words, this exactly means that the detection accuracy of the tap operation is further improved as the sampling frequency is set higher. Specific examples are shown in FIG. 22(A) to FIG. 24(B). FIG. 22(A) is a waveform of the acceleration detection value due to the tap operation obtained when the sampling frequency is set to 200 Hz. FIG. 22(B) is enlargement of a part of FIG. 22(A). Similarly, FIG. 23(A) and FIG. 23(B) are signal waveforms at the sampling frequency of 400 Hz and FIG. 24(A) and FIG. 24(B) are signal waveforms at the sampling frequency of 1620 Hz. Note that, in FIG. 22(B) and the like, 20 ms equivalent to one cycle is set as a target. However, the idea is the same when a half cycle is set as a target.

As shown in FIG. 22(B), by setting 200 Hz, at which sampling at approximately two points per peak is expected, as the sampling frequency, it is possible to detect up-down movement of a signal value in the target period to some extent. Specifically, by setting the sampling frequency to 200 Hz, it is possible to detect the tap operation at accuracy of approximately 70%.

As shown in FIG. 23(B), by setting the sampling frequency to 400 Hz, compared with the case of 200 Hz, it is possible to acquire a change in the signal waveform in the target period more in detail. Therefore, concerning the absolute values of the maximum value and the minimum value of the acceleration detection value, it is possible to acquire values larger than values in the case of 200 Hz. It is possible to suppress the possibility of misdetection in the determination performed using the comparison processing with the threshold. Specifically, by setting the sampling frequency to 400 Hz, it is possible to detect the tap operation at accuracy of approximately 80%.

Similarly, as shown in FIG. 24(B), by setting the sampling frequency to 1620 Hz, it is possible to acquire a more detailed signal waveform compared with the case of 400 Hz. As shown in FIG. 24(B), at the sampling frequency of 1620 Hz, it is possible to almost surely acquire a value at the vertex of the peak. The absolute value of the value is larger than the minimum value and the maximum value at 400 Hz shown in FIG. 20(A) and FIG. 23(B). That is, compared with the case of 400 Hz, it is possible to more surely detect the tap operation. Specifically, it is possible to detect the tap operation at accuracy of approximately 100%.

### 5.3 Setting Method for the Sampling Frequency

As explained above, it is possible to detect the tap operation by setting an appropriate processing target period (tap determination period in FIG. 15(A)) and an appropriate threshold. The detection accuracy of the tap operation is higher as the sampling frequency is set higher. However, when the sampling frequency is set higher, the power consumption of the acceleration sensor 10 also increases. For example, a current amount at the sampling frequency of 200 Hz is approximately 18 μA. The current amount becomes 36 μA at 400 Hz and becomes 100 μA at 1620 Hz.

Therefore, in this embodiment, the setting unit 190 sets the sampling frequency and operates the acceleration sensor 10 using the set sampling frequency. Specifically, in a scene in which it is highly possible that the tap operation is performed or a scene in which detection of the tap operation at high accuracy is requested, the setting unit 190 sets the sampling frequency high. This is based on the idea that the tap operation is one of user interfaces and, in a use case of the electronic apparatus, it is possible to estimate possibility that the tap operation is performed and requested accuracy. More specific examples are explained below.

As the setting timing of the sampling frequency, it is conceivable that operation information is acquired in the input-information acquiring unit 110 or reception of information is performed in the communication unit 170.

Specifically, the operation information is acquired when the operation of the operation unit 160 is performed by the user. The operation of the operation unit 160 is depression of the button or the key, a touch on the touch panel, or the like. In these kinds of operation, in general, the possibility of wrong operation is low compared with the tap operation. This is because, since the button and the key are structured assuming physically depression and are provided in a part of a region of the electronic apparatus, wrong operation is unlikely because the user performs predetermined operation after visually recognizing the button and the like. Concerning the touch panel, although the possibility of touching a position different from an intended position cannot be denied, at least operation based on visual recognition of the user is expected. On the other hand, the tap operation is not particularly limited as to which portion of the electronic apparatus is tapped. Therefore, wrong operation such as inability to give a sufficient shock could occur when operation is performed in a situation in which the electronic apparatus cannot be visually recognized, for example, the electronic apparatus of the wristwatch type is present under a sleeve of clothing or when the user performs operation without looking at the electronic apparatus. Unlike the buttons and the like, it is possible that there is an individual difference in a way of operation (the position, the direction, the strength, and the like of tap) and, even if the user is the same, a difference occurs in every operation.

Therefore, when a series of operation such as an information input is performed, a use case is sufficiently conceivable to, rather than performing the tap operation from the beginning, perform an input by key operation or the like first and, thereafter, perform the tap operation.

For example, it is highly possible that the electronic apparatus of the wristwatch type has a plurality of operation modes, i.e., an information display mode for performing information display of a clock or the like and an information input mode (in a narrow sense, the meal mode explained above) for performing an input of some information. In that case, the information input in the information input mode is stored or used for some processing in the electronic apparatus itself or other systems. Therefore, it is undesirable that, although the user does not intend to input information, the operation mode transitions to the information input mode and inappropriate information is input. In that case, it is desirable to perform, with the operation of the operation unit 160, in which the possibility of wrong operation is low, switching of the operation mode from the information display mode to the information input mode and use the tap operation in an information input after the shift to the information input mode. In such a use case, it can be said that the possibility that the tap operation is performed is high after the operation of the operation unit 160. Therefore, it is desirable to set the sampling frequency high.

It is also conceivable that the electronic apparatus operates in association with other apparatuses such as a smart phone. For example, it is conceivable to associate the electronic apparatus with the smart phone to, for example, operate the electronic apparatus using an operation unit of the smart phone or transfer a part of simple information among detailed information retained by the smart phone to the electronic apparatus and display the simple information on a display unit of the electronic apparatus. More specifically, when the smart phone receives information such as an electronic mail, the user may operate the electronic apparatus to display simple information (information such as a sender name, a title, and a reception date and time) of the electronic mail or a mail text in the electronic apparatus. Alternatively, when the smart phone detects an incoming call, a stop or the like of an incoming call sound may be realized by the operation of the electronic apparatus.

In such a case, some information from the smart phone such as information indicating the reception of the electronic mail or the incoming call is received by the communication unit 170 of the electronic apparatus. That is, like the acquisition of the operation information in the input-information acquiring unit 110, the reception of the information in the communication unit 170 indicates that it is highly possible that the tap operation is performed thereafter. Therefore, when the reception of the information in the communication unit 170 is detected, it is desirable to set the sampling frequency high. In particular, when the stop or the like of the incoming call sound explained above is taken into account, since quicker operation is requested, it is highly possible that the tap operation, which can be easily executed compared with the key operation or the like, is performed. It can be said that an advantage of increasing the sampling frequency is large.

Note that it is desirable that the acquisition of the operation information or the increase in the sampling frequency by the reception of the information in the communication unit 170 is limited to within a predetermined period. Consequently, it is possible to suppress power consumption from increasing because the sampling frequency is high for a long time. When acquisition of operation information or reception of information is detected anew during the predetermined period, the predetermined period has only to be set again starting from timing of the detection. Consequently, it is possible to suppress the sampling frequency from returning to a low state, although it is highly possible that the tap operation is performed.

The sampling frequency may be set on the basis of the worn state of the electronic apparatus by the user. As explained above, the wearing determining unit 180 can determine whether the electronic apparatus is in the worn state or the unworn state by using the detection value in the light receiving unit and the acceleration detection value of the acceleration sensor 10.

In the electronic apparatus of the wristwatch type, it is highly possible that the operation of the electronic apparatus is performed in the worn state. In the unworn state, it is less possible that the electronic apparatus is operated. In particular, concerning the tap operation, since a shock due to a tap is detected using the acceleration sensor 10, it is desirable that the tap operation is performed in a situation in which a shock is sufficiently transmitted, for example, the electronic apparatus is fixed to an arm or the like. It is difficult to assume the tap operation on the electronic apparatus in a hand-gripped state, the electronic apparatus placed on a desk, and the like.

Therefore, when the electronic apparatus is in the unworn state, it is desirable to set the sampling frequency low compared with when the electronic apparatus is in the worn state. Note that the sampling frequency in the unworn state is not prevented from being set to a frequency at which the tap operation can be detected at a certain degree of accuracy such as 200 Hz. For example, the frequency of 400 Hz or 1620 Hz in the worn state may be set to 200 Hz. However, as explained above, the detection of the tap operation is difficult in the unworn state. Therefore, the detection processing itself of the tap operation does not have to be performed. That is, the sampling frequency in the unworn state may be a frequency at which sufficient detection accuracy cannot be achieved, for example, a frequency lower than 200 Hz. Consequently, it is possible to further reduce power consumption.

The setting timing of the sampling frequency is not limited to the setting timing explained above. For example, when the tap operation is detected in a state in which the sampling frequency is low, the sampling frequency may be increased (in a narrow sense, 1620 Hz or the like; a maximum frequency in setting) for a predetermined period.

This is useful, for example, in detecting double-tap operation. In the double-tap operation, as in the double click in a mouse, the tap operation is performed twice in a short period. The tap operation performed twice is interpreted as one user input and treated as an input different from single-tap operation. When the double-tap operation is allowed, it is possible that the tap operation is performed again immediately after the tap operation performed once. Therefore, it is desirable to set the sampling frequency high in order to detect the tap operation performed again. In particular, according to a data analysis by the applicant, it has been found that an acceleration detection value in the second tap operation of the double-tap operation is a small value compared with acceleration detection values of the first tap operation and the single tap operation. Therefore, the possibility that wrong determination occurs in the detection processing of the tap operation, which is the comparison processing with the threshold, increases. Therefore, it is desirable to set the sampling frequency high in order to secure sufficient detection accuracy.

A behavior analysis of the user may be performed to set the sampling frequency on the basis of a result of the behavior analysis. Specifically, when it is determined that the user is in an exercise state, the sampling frequency is set high compared with the case where it is determined that the user is in a non-exercise state.

In the exercise state, acceleration due to the exercise is included in an acceleration detection value of the acceleration sensor 10. A ratio of a signal value of the shock due to the tap operation to the acceleration detection value decreases and detection accuracy of the tap operation is deteriorated. Therefore, in the exercise state, it is desirable to improve the detection accuracy by setting the sampling frequency high.

As an example of a discrimination method for the exercise state, the acceleration detection value of the acceleration sensor 10 has only to be used. When the acceleration detection value is large compared with an acceleration detection value during the normal time, it may be determined that the user is in the exercise state. Alternatively, in walking, running, or the like, since exercise has periodicity, given periodicity is also found in the acceleration detection value. That is, it may be determined according to presence or absence of the periodicity of the acceleration detection value whether the user is in the exercise state. Note that various methods are known concerning the behavior analysis of the user. In this embodiment, since any method is applicable, more detailed explanation is omitted.

5.4 Setting Method for the Threshold Associated with the Sampling Frequency

In the above explanation, the setting unit 190 sets the sampling frequency. However, the setting unit 190 is not limited to the setting of the sampling frequency. The setting unit 190 may change the sampling frequency and perform setting for changing the threshold of the tap operation detection in association with the sampling frequency.

Specifically, the setting unit 190 performs setting for increasing the threshold as the sampling frequency is set higher. For example, when the sampling frequency is changed from F1 to F2 (>F1), the threshold is changed from Th1 to Th2 (>Th1).

As explained above, in order to appropriately detect the tap operation, discrimination processing for discriminating the tap operation from the turning action of the wrist is necessary. Acceleration due to exercise or the like is sometimes included in an acceleration detection value as noise. In this embodiment, on the basis of an idea that an acceleration detection value due to the tap operation is larger than acceleration detection values due to the turning action of the wrist and the noise, a value larger than an upper limit of the acceleration detection values assumed as the turning action of the wrist and the noise is set as the threshold. Note that, concerning an acceleration detection value in the negative direction, a value smaller than a lower limit of the acceleration detection values assumed as the turning action of the wrist and the noise is set as the threshold. However, the value is considered the same as the value in the positive direction by using an absolute value.

In an example shown in FIG. 20(B), the absolute value of the acceleration detection value in the negative direction assumed in the turning action is approximately 2.4 G. Therefore, a value larger than the absolute value is set as the threshold. When the absolute value of a detected acceleration detection value is larger than the threshold, it is determined that the tap operation is detected. However, it is less likely that the same action is always performed every time the turning action of the wrist is performed. The acceleration detection value is different in every action. Therefore, concerning the acceleration detection value of the turning action, it is difficult to clearly determine an upper limit of the absolute value of the acceleration detection value. Therefore, the threshold is desirably set with a certain degree of a margin with respect to a value assumed as an acceleration detection value due to an operation other than the tap operation. In the example shown in FIG. 20(B), if a threshold of −2.5 G is set, depending on a turning action, it is possible that an acceleration detection value having an absolute value larger than the threshold appears. In that case, the turning action is erroneously detected as the tap operation. That is, from the viewpoint of suppressing the possibility that an action other than the tap operation is erroneously detected as the tap operation, it can be said that the absolute value of the threshold is desirably larger. For example, if approximately −4.0 G is set as the threshold, it is possible to sufficiently reduce the possibility that the turning action is erroneously detected as the tap operation.

However, as explained above with reference to FIG. 22(A) to FIG. 24(B), it is more highly possible that the value of the vertex of the peak in the waveform cannot be detected as the sampling frequency is lower. As a result, it is more possible that the acceleration detection value decreases. Therefore, if the absolute value of the threshold is set too large, although the tap operation is performed, the acceleration detection value cannot exceed the set threshold. That is, it is likely that the tap operation is erroneously detected as not being the tap operation.

In view of the above, since there is tendency that the acceleration detection value changes according to the sampling frequency, it can be said that it is preferable to dynamically change the threshold according to the sampling frequency rather than setting the same threshold at all sampling frequencies.

For example, when the sampling frequency is a sufficiently high frequency such as 1620 Hz, the threshold is also set to a high value considering that the acceleration detection value due to the tap operation is sufficiently large. Consequently, it is possible to suppress the possibility that an operation other than the tap operation such as the turning action or the noise is erroneously detected as the tap operation. For example, values indicated by Th3+ and Th3− in FIG. 24(B) have only to be set as the threshold.

On the other hand, when the sampling frequency is a low frequency such as 200 Hz, in order to suppress the possibility that the tap operation is erroneously detected as not being the tap operation, the threshold is set to a small value compared with the case where the sampling frequency is high. In this case, compared with the case where the sampling frequency is 1620 Hz or the like, it is highly possible that an operation other than the tap operation is erroneously detected as the tap operation. However, the erroneous detection is allowed. This is because a situation in which, although the user is performing the tap operation with a clear intension, the tap operation is not recognized by the electronic apparatus gives large stress to the user and is undesirable. For example, as shown in FIG. 22(B), Th1+ and Th1− having an absolute value smaller than Th3+ and Th3− have only to be set as the threshold.

Note that, at an intermediate sampling frequency such as 400 Hz, it is assumed that the acceleration detection value is also an intermediate value. Therefore, as the threshold, as shown in FIG. 23(B), for example, Th2+ satisfying Th1+<Th2+<Th3+ or Th2− satisfying |Th1−|<|Th2−|<|Th3−| has only to be used.

6. Specific Example of a Method in this Embodiment

In an embodiment explained above, the electronic apparatus includes, as shown in FIG. 1, the input-information acquiring unit 110 that performs acquisition processing for input information on the basis of an input from the user, the time-information acquiring unit 120 that acquires time information from the clocking unit 130, the discriminating unit 140 that performs discrimination processing for a mealtime on the basis of the time information, and the processing unit 150 that calculates meal amount information on the basis of the input information acquired by the input-information acquiring unit 110 and performs, on the basis of the calculated meal amount information and a result of the discrimination processing in the discriminating unit 140, determination processing for a calorie amount by a meal.

The mealtime is information indicating whether a target meal is breakfast, lunch, or dinner. As explained above, the mealtime may be information indicating meals such as eating between meals and a night meal other than breakfast, lunch, and dinner. The meal amount information is information representing, concerning the target meal, a degree of an intake amount of the meal and, specifically, is information representing “large”, “normal”, and “small” of a meal amount. However, as explained above with reference to FIG. 5 and the like, the meal amount information is not limited to information representing a simple amount and may be information including, for example, presence or absence of drinking.

Consequently, the mealtime can be automatically determined by the discrimination processing by the discriminating unit 140. Therefore, when a calorie amount by a meal is recorded, it is possible to facilitate an input by the user. Specifically, as shown in FIG. 6, an input concerning the mealtime may be completely skipped. As shown in FIG. 11, an initial selected state of the mealtime may be automatically determined to reduce the number of times of the selection operation.

Note that, in the above explanation, the electronic apparatus includes the clocking unit 130 and the operation unit 160. The processing from an input by the user to determination (calculation) of a calorie amount based on the input is performed by the electronic apparatus. However, the electronic apparatus is not limited to this. For example, when the wristwatch type device shown in FIG. 12 and an electronic apparatus such as a smart phone operate in association with each other, the electronic apparatus in this embodiment may be realized as the smart phone or the like. In this case, an operation input by the user is performed on the operation unit of the wristwatch type device. The input-information acquiring unit 110 of the electronic apparatus, which is the smart phone, acquires information based on the operation on the operation unit via a network such as short-range radio communication. In general, the electronic apparatus such as the smart phone includes the clocking unit 130. However, the time-information acquiring unit 120 of the electronic apparatus may acquire the time information from the clocking unit of the wristwatch type device via the network. The calculated calorie amount is not prevented from being stored by the electronic apparatus such as the smart phone. However, when it is taken into account that, for example, calorie amounts from a large number of users are accumulated and analyzed over a long period, a result of the arithmetic processing in the processing unit 150 may be transmitted to a server system or the like. Alternatively, the electronic apparatus in this embodiment may be realized as the server system.

The input-information acquiring unit 110 may perform acquisition processing for input information by the tap operation of the user as shown in FIG. 12.

Consequently, it is possible to perform input processing using the tap operation. As explained above, it is also conceivable that, depending on an implementation form of the electronic apparatus, the electronic apparatus is limited in the number and the size of the operation units 160 such as keys or buttons, and the like. In that case, even if a physical structure such as a button is absent, the tap operation detectable from sensor information received from the acceleration sensor 10 is a useful interface. Note that a detection method for the tap operation in this embodiment is optional. However, a method of realizing an appropriate balance of detection accuracy and power consumption by, for example, variably setting the sampling frequency and the threshold as explained above may be used.

When first to N-th (N is an integer equal to or larger than 2) meal amounts are set as the meal amount represented by the meal amount information, in a selected state of an i-th (i is an integer satisfying 1≦i≦N, i≠N) meal amount, when the input-information acquiring unit 110 performs the acquisition processing for input information by the tap operation, the processing unit 150 may determine that an i+1-th meal amount is in a selected state and perform the determination processing for a calories amount using the i+1-th meal amount as the meal amount information.

Further, in a selected state of the N-th meal amount, when the input-information acquiring unit 110 performs the acquisition processing for the input information by the tap operation, the processing unit 150 may determine that the first meal amount is in a selected state and perform the determination processing for a calories amount using the first meal amount as the meal amount information.

Consequently, it is possible to realize the screen transition by the tap operation shown in FIG. 8. In a scene in which the tap operation is useful, it is highly possible that types of operation executed by the user are limited. Therefore, it is sometimes difficult to freely realize transition from a selected state of given meal amount information to a selected state of any other meal amount information. In that case, the interface in which selected states are sequentially switched one by one and return from last meal amount information to first meal amount information is easily realized, easily seen for the user, and extremely useful.

The input-information acquiring unit 110 may acquire personal data of the user as input information. The processing unit 150 may perform, on the basis of meal amount information representing a k-th (k is an integer satisfying 1≦k≦N) meal amount in a selected state and the mealtime discriminated by the discrimination processing, determination processing for a k-th calorie amount, which is a calorie amount corresponding to intake of a meal with the k-th meal amount at a mealtime for the user.

The personal data of the user is age, sex, a physical activity level, and the like of the user and is, in a narrow sense, information used in determining the parameters of the above Expression (1). However, the personal data is not limited to this and may include information such as height and weight of the user. Consequently, it is possible to calculate an intake calorie amount on the basis of the personal data, the mealtime determined on the basis of the automatic discrimination, and the meal amount information input by the user. A specific method is as explained above with reference to the above Expressions (1) and (2).

The processing unit 150 may perform, on the basis of arithmetic processing for the k-th calorie amount, output processing for information for display control used for display of the k-th meal amount and the k-th calorie amount.

Consequently, as indicated by numerical values under the meal amounts such as “rather small” and “rather large” in D2a to D2c and the like in FIG. 8, it is possible to, for example, display, on a real-time basis, an intake calorie amount corresponding to meal amount information in a selected state. Therefore, since the displayed intake calorie amount in the meal amount information is presented to the user, the user can learn, on the site, a calorie amount taken by the user. For example, when the input in this embodiment is performed, for example, before a meal is taken or immediately after the meal is taken, the user can recognize a calorie amount to be taken or a taken calorie amount on a real-time basis. Therefore, the user can perform behavior to, for example, reduce a meal amount in the next meal because the user ate too much in this meal. A maintenance and promotion effect for health is improved. Note that, when the electronic apparatus in this embodiment is realized as a smart phone or a server system, information for display control may be output to and displayed on a display unit of the electronic apparatus itself. However, when the effect is taken into account, the information for display control is desirably output to an apparatus set as a visual recognition target by the user, for example, the wristwatch type device shown in FIG. 12.

The processing unit 150 may perform the mode switching processing for switching the operation mode of the electronic apparatus between the information display mode for performing display of information and the meal mode for performing processing concerning a meal. The time-information acquiring unit 120 may acquire time information at switching timing when the operation mode is switched from the information display mode to the meal mode by the processing unit 150. The discriminating unit 140 may perform the discrimination processing for a mealtime on the basis of the time information at the switching timing.

Consequently, as shown in FIG. 6 and the like, it is possible to determine a mealtime using timing when the operation mode is switched from the information display mode (in a narrow sense, a clock display mode) to the meal mode. This is useful when input operation is performed immediately before or immediately after a meal. However, in the electronic apparatus in this embodiment, the input operation may be performed at timing different from meal timing to collectively input meal information for a plurality of times of meals afterward. In that case, the discrimination processing for a mealtime may be performed according to time information at timing different from the switching timing to the meal mode.

The processing unit 150 may perform the mode switching processing for switching the operation mode of the electronic apparatus between the information display mode for performing display of information and the meal mode for performing processing concerning a meal. The input-information acquiring unit 110 may perform the acquisition processing for input information by the tap operation of the user and input information by an operation input of the operation unit. When the operation mode is the information display mode, when the input-information acquiring unit acquires input information by an operation input of the operation unit, the processing unit 150 may perform the mode switching processing for switching the operation mode to the meal mode.

Consequently, the input-information acquiring unit 110 is capable of using operation by the operation unit 160 as a trigger of the mode switching processing to the meal mode while enabling reception of both of the operation by the operation unit 160 and the tap operation. A calorie amount calculated on the basis of an input in a meal mode is accumulated in, for example, a server system and used for, for example, advice generation processing for health maintenance and promotion. That is, it is undesirable that the operation mode shifts to the meal mode by mistake and information not intended by the user is input. Therefore, when both of the operation by the operation unit 160 and the tap operation can be received, it is desirable to use, as a trigger of the mode switching processing to the meal mode, the operation by the operation unit 160 in which possibility of erroneous operation is lower.

When a plurality of meal amounts are set as the meal amount represented by the meal amount information and when the operation mode is the meal mode and when the input-information acquiring unit 110 performs the acquisition processing for the input information by the tap operation, the processing unit 150 may perform processing for setting, in a selected state, a meal amount different from a meal amount in a selected state before the tap operation among the plurality of meal amounts. When the input-information acquiring unit 110 performs the acquisition processing for input information by an operation input of the operation unit 160, the processing unit 150 may perform the determination processing for a meal amount in a selected state and perform the switching processing for switching the operation mode to the information display mode.

Consequently, even in the meal mode, the input-information acquiring unit 110 enables reception of both of the operation by the operation unit 160 and the tap operation and processes the tap operation as an operation for transitioning a selected state of meal amount information. The operation by the operation unit 160 can be used as a trigger of an operation for deciding the meal amount information in the selected state and the mode switching processing for shifting to the information display mode. As explained above, in the electronic apparatus assumed in this embodiment, it is possible that a degree of freedom of operation is not high. Therefore, in the selection processing for meal amount information, a plurality of times of operation inputs are sometimes necessary. Therefore, it is desirable to use, as operation for transitioning a selected state, the tap operation that can be relatively easily input. For the decision of the meal amount information and the switching of the operation mode, since wrong operation is undesirable, it is desirable to use the operation by the operation unit 160 in which the possibility of wrong operation is relatively low.

Note that this embodiment is explained in detail above. However, those skilled in the art could easily understand that many modifications not substantially departing from the new matters and the effects of the present invention are possible. Therefore, all such modifications are deemed to be included in the scope of the invention. For example, terms described together with broader-sense or synonymous different terms at least once in the specification or the drawings can be replaced with the different terms in any place of the specification or the drawings. The components and the operations of the electronic apparatus are not limited to the components and the operations explained in this embodiment. Various modified implementations are possible.

What is claimed is:

1. An electronic apparatus comprising:
an input-information acquiring unit configured to perform acquisition processing for input information on the basis of an input from a user;
a time-information acquiring unit configured to acquire time information from a clocking unit;
a discriminating unit configured to perform discrimination processing for a mealtime on the basis of the time information; and
a processing unit configured to calculate meal amount information on the basis of the input information acquired by the input-information acquiring unit and perform determination processing for a calorie amount by a meal on the basis of the calculated meal amount information and a result of the discrimination processing in the discriminating unit.

2. The electronic apparatus according to claim 1, wherein the input-information acquiring unit performs the acquisition processing for the input information by tap operation by the user.

3. The electronic apparatus according to claim 2, wherein, when first to N-th (N is an integer equal to or larger than 2) meal amounts are set as a meal amount represented by the meal amount information, in a selected state of an i-th (i is an integer satisfying 1≦i≦N, i≠N) meal amount, when the input-information acquiring unit performs the acquisition processing for the input information by the tap operation, the processing unit determines that an i+1-th meal amount is in a selected state and performs the determination processing for the calorie amount using the i+1-th meal amount as the meal amount information.

4. The electronic apparatus according to claim 3, wherein, in a selected state of the N-th meal amount, when the input-information acquiring unit performs the acquisition processing for the input information by the tap operation, the processing unit determines that the first meal amount is in a selected state and performs the determination processing for the calorie amount using the first meal amount as the meal amount information.

5. The electronic apparatus according to claim 3, wherein
the input-information acquiring unit acquires personal data of the user as the input information, and
the processing unit performs, on the basis of the personal data, the meal amount information indicating a k-th (k is an integer satisfying 1≦k≦N) meal amount in a selected state, and the mealtime discriminated by the discrimination processing, the determination processing for a k-th calorie amount, which is the calorie amount corresponding to intake of a meal with the k-th meal amount at the mealtime by the user, and performs output processing for information for display control used for display of the k-th meal amount and the k-th calorie amount.

6. The electronic apparatus according to claim 1, wherein
the processing unit performs mode switching processing for switching an operation mode of the electronic apparatus between an information display mode for performing display of information and a meal mode for performing processing concerning a meal,
the time-information acquiring unit acquires the time information at switching timing when the operation mode is switched from the information display mode to the meal mode by the processing unit, and
the discriminating unit performs the discrimination processing for the mealtime on the basis of the time information at the switching timing.

7. The electronic apparatus according to claim 1, wherein
the processing unit performs mode switching processing for switching an operation mode of the electronic apparatus between an information display mode for performing display of information and a meal mode for performing processing concerning a meal,
the input-information acquiring unit performs the acquisition processing for the input information by tap operation by the user and the input information by an operation input of an operation unit, and
when the operation mode is the information display mode, when the input-information acquiring unit acquires the input information by the operation input of the operation unit, the processing unit performs the mode switching processing for switching the operation mode to the meal mode.

8. The electronic apparatus according to claim 7, wherein
when a plurality of meal amounts are set as a meal amount represented by the meal amount information and when the operation mode is the meal mode, the processing unit performs processing for changing, to a selected state, the meal amount different from the meal amount in a selected state before the tap operation among the plurality of meal amounts when the input-information acquiring unit performs the acquisition processing for the input information by the tap operation and performs determination processing for the meal amount in the selected state and performs the mode switching processing for switching the operation mode to the information display mode when the input-information acquiring unit performs the acquisition processing for the input information by the operation input of the operation unit.
